(19) United States
(12) Patent Application Publication
(10) Pub. No.: US 2005/0234686 A1
(43) Pub. Date: Oct. 20, 2005

(54) Analysis method and system

(76) Inventors: Hongwei Cheng, Old Greenwich, CT (US); Leslie Frederick Greengard, New York, NY (US); Zydrunas Gimbutas, Hamden, CT (US); Per-Gunnar Johan Martinsson, New Haven, CT (US); Vladimir Rokhlin, Hamden, CT (US)

Correspondence Address: FULBRIGHT & JAWORSKI, LLP, 666 FIFTH AVE, NEW YORK, NY, 10103-3198, US

(21) Appl. No.: 11/053,159

(22) Filed: Feb. 7, 2005

Related U.S. Application Data
(60) Provisional application No. 60/542,666, filed on Feb. 6, 2004.

(51) Int. Cl. G06F 17/10

(52) U.S. Cl. 703/2

(57) ABSTRACT

A fast direct method for the solution of structured linear systems of equations. A linear system with a matrix that possesses larger submatrices that are of low ranck (to some precision).

### RELATED APPLICATION

The present application claims a priority to U.S. Provisional Patent Application Ser. No. 60/542,666, which is incorporated herein by reference in its entirety.

### BACKGROUND OF THE INVENTION

The present invention relates to a method and system for analyzing a linear system, more particularly to analyzing a linear system with a matrix that possesses large sub-matrices that are of low rank.

In applications such as electromagnetic scattering, electromagnetic compatibility analysis, cross-talk, interconnect, signal integrity analysis, finding modes in optical waveguides, and other EDA applications, it is necessary to solve systems of the form Fᵢⱼσⱼ=fᵢ, where up to minor modification
Fᵢⱼ=exp(ik∥xᵢ−xⱼ∥)/∥xᵢ−xⱼ∥,
fᵢ=f(xᵢ) are given data, and σⱼ=σ(xⱼ) are the physical quantities of interest that are to be determined. Other choices of kernel Fᵢⱼ are used in fluid dynamics, statistical applications, and in general purpose engineering/scientific software libraries.

In the prior art, one usually solves such systems by iterative methods. Major limitations of this approach are: 1) when the linear system is ill-conditioned, the iterative methods tend converge poorly, this situation arises, for example, for near-resonant structures, such as in antenna design, or optical waveguide mode analysis, or parasitic effect or cross-talk analysis, 2) the iterative solvers derive very little advantage from closeness of small changes in the matrix Fᵢⱼ due to small changes in geometry, 3) inability efficiently handle multiply right hand sides.

Another set of techniques are so called the fast direct solvers that address most of the deficiencies of iterative methods. For example, fast direct solvers for scattering from elongated objects have been published in the engineering literature. However, they have a drawback of not handling more complicated geometries described by general curves or surfaces, also these methods have been hard to extend to more general class of interaction kernels. Yet another class of fast direct solvers rely on Green's formula for underlying algorithms to work. This introduces numerical problems if some points of discretization are close to (internal) boundaries where Green's formula is applied.

Hence it is desirable to have a fast direct solver which has the extra desired properties of being easily expandable to more general class of kernels while handling more complicated geometries efficiently. In addition, it is extremely desirable to introduce an alternative representation replacing Green's formula in order to improve internal conditioning of the algorithm. Thus, the present invention is directed to a fast direct solver that has all these requirements.

The fast direct solver of the present invention has been used for solving electromagnetic scattering problems from long thin geometries, for calculating the modes in optical waveguides, fast solution of Laplace equation for capacitance extraction used in Electronic Design Automation (EDA) tools, and fast solution of Helmholtz acoustical scattering from complicated geometries and rough surfaces.

### OBJECT AND SUMMARY OF THE INVENTION

Therefore, it is an object of the present invention to provide a fast direct method and system, which overcomes the above-noted shortcomings of the traditional fast direct solver.

The present invention is directed to a fast direct method of the solution of structured linear systems of equations as may be used in, for example, Electronic Design Automation (EDA), statistics, computer vision, and image analysis.

There are many problems in computational (broadly speaking) where an essential step involves the solution of a large linear system of equations (Fσ=f) for which there is a well-defined “kernel” which defines the matrix entries Fᵢⱼ. The following is meant by this: that there is a function f such that Fᵢⱼ=F(xᵢ,yⱼ) for some set of points xᵢ, yⱼ which lie on th plane R², three dimensional space R³, or some more general complex space C^{k}.

For example, in Electronic Design Automation (EDA) industry, examples include, but are not limited to capacitance and inductance extraction, signal integrity/interconnect/crosstalk analysis, and electromagnetic compatibility analysis, where up to minor modification
Fᵢⱼ=exp(ik∥xᵢ−xⱼ∥)/∥xᵢ−xⱼ∥.

In statistics, for example, computer vision, and vision analysis, methods based on kernel density estimation rely on similar linear algebraic systems, where the kernel function is often a Gaussian, so that
Fᵢⱼ=exp(−∥xᵢ−xⱼ∥²/t).

In high-dimensional interpolation and approximation, for example, radial basis functions require the solution of linear equations with various kernels including
Fᵢⱼ=exp(−∥xᵢ−xⱼ∥²/t),
Fᵢⱼ=∥xᵢ−xⱼ∥log(∥xᵢ−xⱼ∥),
Fᵢⱼ=∥xᵢ−xⱼ∥.

More generally, nearly all integral equation techniques in electro-magnetics, computational fluid dynamics, and linear elasticity give rise to such problems. Thus, a new method for solving the dense linear systems of equation which arise from discretization has broad potential application in engineering software.

For example, there are three settings where the solver of the present invention is of particular value:

1. when the linear system is “ill-conditioned” and iterative methods converge poorly. This notion is difficult to quantify precisely, but let us define ill-conditioned to mean that more than 100 iterations of the generalized minimal residue algorithm (GMRES) are required to achieve the desired precision.

2. when the same linear system needs to be solved for multiple right hand sides.

3. when a sequence of linear systems is to be solved, each a perturbation of some original system matrix.

All three of these scenarios arise in EDA applications. The first arises, for example, when parts of a circuit are nearly resonant with each other either as a parasitic effect or as an intrinsic part of antenna design. The second setting arises, for example, in interconnect/cross-talk analysis when a specific chip design is being simulated and an engineer wants to check the effects of charging up a sequence of traces, one after other. Each such calculation leaves the system matrix unchanged—it simply requires solving the same linear system for a new right-hand side. The third setting arises, for example, when a designer wants to leave a bulk of the design intact but change the layout of a small substructure. This could happen if a parasitic effect is discovered and a new layout is being investigated in order to avoid it.

The analogous scenarios can arise in fluid dynamics or structural mechanics (linear elasticity). In non-parametric statistics, the second setting arises when a specific estimation model is run on a sequence of data sets. The third setting arises when small changes are introduced into the model itself (such as ignoring the readings from a particular sensor, a particular spot on a gene expression micro-array chip, etc.)

In accordance with an embodiment of the present invention, the present system and method provides an algorithm for the direct solution of systems of linear algebraic equations associated with the discretization of boundary integral equations with non-oscillatory kernels in two dimensions. The algorithm is “fast” in the sense that its asymptotic complexity is O(nlog ^{κ}n), where n is the number of nodes in the discretization, and κ depends on the kernel and the geometry of the contour (κ=1 or 2). Unlike previous fast techniques based on iterative solvers, the present algorithm directly constructs a compressed factorization of the inverse of the matrix; thus it is suitable for problems involving relatively ill-conditioned matrices, and is particularly efficient in situations involving multiple right hand sides.

In accordance with an embodiment of the present invention, a procedure is reported for the compression of rank-deficient matrices. A matrix A of rank k is represented in the form A=U∘B∘V, where B is a k×k submatrix of A, and U, V are well-conditioned matrices that each contain a k×k identity submatrix. This property enables such compression schemes to be used in certain situations where the SVD cannot be used efficiently.

A novel procedure is presented for the compression of rank-deficient matrices. It expresses the columns and the rows of a matrix A as a linear combination of k selected columns and k selected rows of A. The selection defines a k×k submatrix B of A, and the action of A is represented as an action of the submatrix B.

This procedure allows for simple geometrical and physical interpretation of the action of A. The resulting representation are much easier to manipulate and interpret that standard QR and SVD type representations.

Furthermore, the costs of constructing such representation is considerably less expensive than constructing the singular value decomposition (SVD) of A, and so are the costs of applying the factorization to an arbitrary matrix.

A modification the compression scheme is presented for the non-oscillatory problems in two-dimensions. The scheme is considerably faster than a general technique.

The modified scheme can be also applied to other equations from potential theory: Maxwell, Helmholtz, Yukawa, Schrodinger, etc. The method experiences very few problems for the objects smaller than several hundred wavelengths.

New fast methods for recursively splitting and merging the scattering matrices provided that are using low rank arguments to speed up the calculations.

The advantages of such representation by constructing a fast direct solver for the integral equations of potential theory are shown. The algorithm is fast in the sense that its complexity is O(N log ^{k}N) for non-oscillatory problems on one-dimensional curves and O(n^{3/2}) in general.

The solver is particularly suitable for solving ill-conditioned problems.

The solver outperforms the iterative solvers when several right hand sides are involved.

The solver easily adapts to small changes (perturbations) in the geometry of the underlying problem.

Various other objects, advantages and features of this invention will become readily apparent from the ensuing detailed description and the appended claim.

### BRIEF DESCRIPTION OF THE DRAWINGS

The following detailed description, given by way of example, and not intended to limit the present invention solely thereto, will best be understood in conjunction with the accompanying drawings and Appendix in which:

FIG. 1 shows an example of a quad-tree in accordance with an embodiment of the present invention;

FIG. 2 shows an example of a modified quad-tree in accordance with an embodiment of the present invention;

FIG. 3 demonstrates an exemplary definition of projection operators used in the construction of compression matrices in accordance with an embodiment of the present invention;

FIG. 4 demonstrates an exemplary definition of expansion operators used in the construction of compression matrices in accordance with an embodiment of the present invention;

FIG. 5 demonstrates an exemplary definition of evaluation operators used in the construction of compression matrices in accordance with an embodiment of the present invention;

FIG. 6 demonstrates an exemplary compression of a matrix, applying the decomposition involving expansion, and evaluation operators, together with a small sub-matrix of the original matrix, in accordance with an embodiment of the present invention;

FIG. 7 shows an example of the scattering potentials formed in the parent box in accordance with an embodiment of present invention, and applying Step 3 of the pseudo-code to form the scattering potentials on two subscatterers;

FIG. 8 shows an example of the two scattering potentials formed in the children boxes in accordance with an embodiment of the present invention, and applying Step 2 of the pseudo-code to form the scattering potential on the big subscatterers, and applying Step 2A of the pseudo code to exchange the incoming and outgoing scattered potentials of two subscatterers.

FIG. 9 shows an example of a parent box in a modified quad-tree in accordance with an embodiment of the present invention, and applying one step of the modified quad-tree algorithm to form two smaller (children) sub-boxes;

FIGS. 10(A)-(D) are flowcharts describing the process of the present invention in accordance with an embodiment of the present invention;

FIG. 11 graphically illustrates the single-level matrix compression in accordance with an embodiment of the present invention;

FIG. 12 graphically illustrates the multi-level matrix compression in accordance with an embodiment of the present invention;

FIGS. 13(a), (b) are exemplary diagrams of contours r;

FIG. 14 is an exemplary diagram of a smooth contour;

FIG. 15 is an exemplary diagram of the smooth contour of FIG. 14 after two rounds of compression in accordance with an embodiment of the present invention;

FIG. 16(a) is a rippled contour and FIG. 16(b) is a close-up of the area marked by a dashed rectangle in FIG. 16(a);

FIG. 17 is an exemplary contour the shape of a smooth pentagram;

FIG. 18 is an exemplary plot of σₘᵢₙ versus k for an interior Helmholtz problem on the contour shown in FIG. 17;

FIG. 19 is an exemplary star-fish lattice contour;

FIG. 20(a) shows a close-up of the star-fish lattice of FIG. 19 and FIG. 20(b) shows the nodes remaining after the interaction between the cluster formed by the points inside the parallelogram and the remainder of the contour has been compressed;

FIG. 21(a) interaction between Γ₁ and the other contours is compressed, FIG. 21(b) interaction with Γ₂ is compressed, FIG. 21(c) interaction with Γ₃ is compressed;

FIG. 22(a) shows the interaction between Γᵢ (shown in bold) and the remaining contours and FIG. 22(B) shows interactions between the contours drawn with a solid line in FIG. 22(a);

FIG. 23(a) shows the full contour and a box (which is not part of the contour) that indicates the location of the close-up shown in FIG. 23(b);

FIGS. 24(A)-(B) are plots of the singular values of (a) V⁽ⁱ⁾ and (b) H⁽ⁱ⁾ for a discretization of the double layer kernel associated with the Laplace operator on the nine contours depicted in FIG. 22(a); and

FIG. 25 is a plot of the singular values of X⁽ⁱ⁾=[H⁽ⁱ⁾|(V⁽ⁱ⁾)*] where H⁽ⁱ⁾ and V⁽ⁱ⁾ are as in FIG. 24.

### DETAILED EMBODIMENT OF THE PRESENT INVENTION

In accordance with an embodiment, the fast direct method and system of the present invention is directed to solving an acoustic scattering problem associated with the design of the modes in a waveguide. For simplicity, the acoustic scattering problem is modeled as a Dirichlet problem for the Helmholtz equation, and the mathematical formulation of the model problem is given by the formula
−2iσ(x)+∫(∇_{n(y)}+ik)G(x,y)σ(y)=f(x)
for the induced charge density σ, where G(x,y)=H₀(k∥x−y∥), is the free space Green's function for the Helmholtz equation in R², and the scattered fields satisfy Sommerfeld radiation condition at infinity. See e.g., V. ROKHLIN, Solution of Acoustic Scattering Problems by Means of Second Kind Integral Equations, Wave Motion, 5:257 (1983), which is incorporated herein by reference its entirety.

The kernel of integral equation involves log-singular kernel that was discretized using a high-order locally corrected trapezoidal quadrature rules. See e.g., S. KAPUR, V. ROKHLIN, High-Order Corrected Trapezoidal Quadrature Rules for Singular Functions, SIAM Journal of Numerical Analysis, v. 34, No. 4, pp. 1331-1356, 1997, which is incorporated herein by reference in its entirety. After discretization, the integral equation is converted to a system of linear equations
Fᵢⱼσⱼ=fᵢ.

The above linear system of equations is solved via a fast direct method of the present invention that involves a hierarchical compression of the matrix F while simultaneously building a hierarchically compressed inverse of the matrix F.

Like most algorithms for the direct solution of systems of linear algebraic equations, the fast direct procedure of the present invention relies on a factorization of the matrix of the system. However, the factorization can be quite involved, hence the present procedure describes the factorization in terms of “potentials,” “expansions,” and other similar concepts from physics, even though there is an underlying purely algebraic procedure. It is appreciated that this is similar to the way Fast Multipole Algorithms are normally viewed. See e.g. XIAOBAI SUN, NIKOS P. PITSIANIS, A Matrix Version of the Fast Multipole Method, SIAM Review, Vol. 43, No. 2, pp. 289-300, which is incorporated herein by reference in its entirety. Thus, the present procedure comprises two parts: the construction of the factorization and the application of the inverse of the factored matrix to an arbitrary vector. It is appreciated that the factorization is incomparably more expensive to compute than the application of the inverse of factored matrix.

### Mathematical and Numerical Preliminaries

Notation

The linear operators C^{m}→Cⁿ are used throughout herein and the matrix of the operator A: C^{m}→Cⁿ will also be simply denoted as A. For an integer k and positive real ε, the rank of A to precision ε (to be denoted R_{ε}(A)) is assumed equal to k whenever in the singular value decomposition
A=U∘D∘V, (1)
D_{k,k}≧ε (2)
and
   D_{k+1,k+1}<ε (3)

Denoting by \overline{D} the diagonal matrix such that
\overline{D}_{i,i}=D_{i,i} (5)
for all i≦k, and
\overline{D}_{i,i}=0 (5)
for all i>k, the mapping Ã: C^{m}→Cⁿ is defined by the formula
Ã=U∘\overline{D}∘V. (6)

Now, the present system and method defines the kernel of A to precision ε(to be denoted by Ker_{ε}(A) as Ker(Ã)); similarly, Im(Ã)⊂Cⁿ will be denoted by Im_{ε}(A), and referred to as the image of A to precision ε. As used herein, the present system and method refers to R_{ε}(A), Ker_{ε}(A), Im_{ε}(A) as rank, kernel, and image of A, respectively.

In agreement with an accepted practice, the elements of the standard basis in Cⁿ are denoted by eᵢ, with i=1, 2, . . . , n, so that the e₁=(1, 0, 0, . . . , 0), e₂=(0, 1, 0, . . . , 0), . . . , eₙ=(0, 0, 0, . . . , 1). Given an integer m>0 and a subset
Ω={i₁,i₂, . . . ,iₘ} (7)
of the set of integer numbers 1, 2, . . . ,n (to be referred to as an m-string), the m-dimensional subspace of Cⁿ spanned by the elements eᵢ₁, eᵢ₂, . . . eᵢₘ are denoted by by U_{Ω}. The standard embedding U_{Ω}→Cⁿ will be denoted by Im_{Ω}, the orthogonal projection Cⁿ→U_{Ω} will be denoted by P_{Ω}, and the set of all strings of the form (7) will be denoted by l′ₙ^{m}.
Compression of Linear Operators

Herein, A shall denote a linear mapping C^{m}→Cⁿ, such that with R_{ε})(A)=k, with k<min(m,n). Given two strings ΩεΓₘ^{k}, ΥεΓₙ^{k}, the mapping U_{Ω}→U_{Υ} shall be denote by Q_{Ω,Υ} and defined by the formula
Q_{Ω,Υ}=P_{Υ}∘A∘Im_{Ω}. (8)

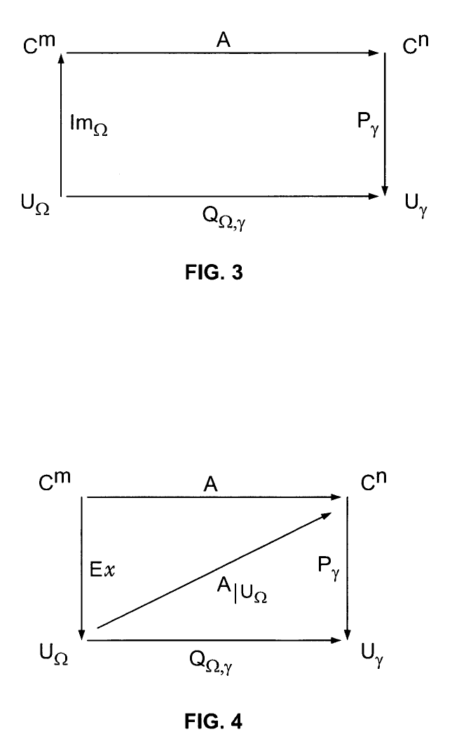

The definition (8) above is illustrated by the commutative diagram in FIG. 3.

The following theorem is one of principal analytical tools of this present invention.

Theorem 2.1: Assume that A is a matrix Cⁿ→C^{m}, and that R_{ε}(A)=k, with k<min(m,n). Then there exist such strings Ω={i₁,i₂, . . . ,iₖ}εΓₘ^{k}Υ={j₁,l₂, . . . ,jₖ}εΓₙ^{k}, and linear mappings Ex: C^{m}→U_{Ω}, Ev: U_{Υ}→Cⁿ, that
Q_{Ω,Υ}∘Ex=P_{Υ}∘A, (9)
A∘Im_{Ω}∘Ex=A, (10)
Ev∘Q_{Ω,Υ}=A∘Im_{Ω}, (11)
Ev∘P_{Υ}∘A=A, (12)
A=Ev∘Q_{Ω,Υ}∘Ex (13)
to precision ε.

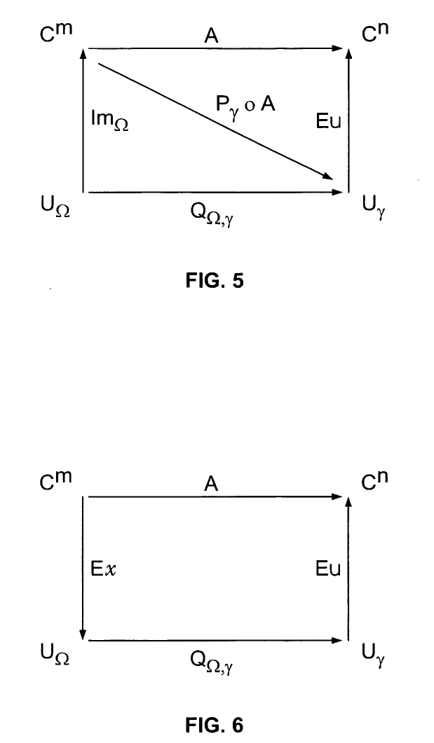

Obviously, (9), (10) are equivalent to the statement that the diagram in FIG. 4 is commutative to precision ε. Similarly, (11), (12) are equivalent to the statement that the diagram in FIG. 5 is commutative to precision ε. Finally, (13) is equivalent to the statement that the diagram in FIG. 6 is commutative to precision ε.

Theorem 2.1 has a simple numerical interpretation. Specifically, it says that given a matrix A whose rank k is less than either of its dimensionalities, it is possible to find a k×k-submatrix Q of A and mappings Ex, Ev that “compress” A via (13). In this sense, (13) is similar to the Singular Value Decomposition (1); however, (13) is considerably less expensive to construct, and is somewhat more efficient as a representation for A.

Numerical Apparatus

A simple and reasonably efficient procedure for computing the factorization (13) is presented herein in accordance with an embodiment of the present invention. Given an m×n matrix A, the first step (out of four) is to apply the pivoted Gram-Schmidt process to its columns. The process is halted when the column space has been exhausted to a preset accuracy ε, leaving a factorization
AP_{R}=Q[R₁₁|R₁₂], (14)
where PRεC^{n×n} is a permutation matrix, QεC^{m×k} has orthonormal columns, R₁₁εC^{k×k} is upper triangular, and R₁₂εC^{k×(n-k)}.

The second step is to find a matrix TεC^{k×(n-k)} that solves the equation
R₁₁T=R₁₂ (15)
to within accuracy ε. When R₁₁ is ill-conditioned, there is a large set of solutions; one for which ∥T∥_{F} is small is selected.

Letting A_{CS}εC^{m×k} denote the matrix formed by the first k columns of AP R, a factorization is obtained
A=A_{CS}[I|T]P_{R}*. (16)

The third and the fourth steps are entirely analogous to the first and the second, but are concerned with finding k rows of A_{CS} that form a basis for its row-space. They result in a factorization

$${A}_{CS} = {P}_{L} ⌊ \frac{I}{S} ⌋ {A}_{S} . \qquad ( 17 )$$

The desired factorization is now obtained by inserting (17) into (16):

$$A = {P}_{L} [ \frac{I}{S} ] {A}_{S} [ I ] [ T ] {P}_{R}^{*} . \qquad ( 18 )$$

and defining

$$E v = {P}_{L} [ \frac{I}{S} ] , \\ {Q}_{Ω , Υ} = {A}_{S} , \\ E x = [ I \vert T ] {P}_{R}^{*} .$$

For this technique to be successful, it is important that the Gram-Schmidt factorization be performed accurately. Modified Gram-Schmidt or the method using Householder reflectors are not accurate enough. Instead, the present invention uses a technique that is based on modified Gram-Schmidt, but that at each step re-orthogonalizes the vector chosen to add to the basis before adding it. In exact arithmetic, this step would be superfluous, but in the presence of round-off error it greatly increases the quality of the factorization generated, see e.g. Å Björck, Numerics of Gram-Schmidt orthogonalization, Linear Algebra Appl., vol. 197/198, pp. 297-316, 1994, which is incorporated herein by reference in its entirety.

Quad-Trees and Modified Quad-Trees

Quad-trees are a classical tool of Computer Science, widely used in image processing, data handling, and several other areas. Their use in numerical analysis seems to have originated with the Fast Multipole Method (see, for example, J. CARRIER, L. GREENGARD, V. ROKHLIN, A Fast Adaptive Multipole Algorithm for Particle Simulations, SIAM Journal of Scientific and Statistical Computing, 9(4), 1988, which incorporated herein by reference in its entirety), and is common by now.

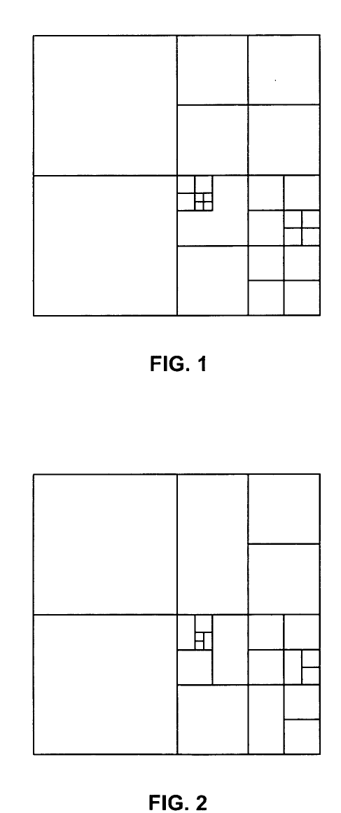

Without loss of generality, the structure (i.e., the scatterer) can be assumed to be simulated is contained inside a square of size 1, centered about the origin of the system of coordinates; this square will be referred to as the computational box. A hierarchy of meshes is introduced, subdividing the computational domain into smaller and smaller regions (see FIG. 1). The quad-tree in FIG. 1 is shown as a collection of rectangles (in 2 dimensions, or rectangular boxes higher dimensions) formed by starting with a rectangle that contains the entire set of points on discretized geometry (referred to as the computational box), and recursively dividing the set of boxes according to the algorithm described in the U.S. Provisional Patent Application Ser. No. 60/542,666.

Mesh level 0 corresponds to the whole computational domain, while mesh level l+1 is obtained from mesh level 1 by subdividing each square into 4 equal parts. A tree structure is imposed on the mesh hierarchy, so that if b is a fixed box on the level 1, the four boxes on the level l+1 obtained by subdividing b are referred to as b's children. The four children of the same box will be referred to as brothers. Some integer s≧1 is chosen, and at every level of refinement, only those boxes are subdivided that contain more than s nodes. For non-uniform structures, this results in a large number of empty boxes; once an empty box is encountered, its existence is immediately forgotten, and it is not considered a part of the structure.

It is convenient to modify the above structure slightly, so that each box has only one brother, instead of three. The price to be paid for this modification is that now the boxes on all odd levels of subdivision are rectangles rather than squares; each of such rectangles is twice as tall as it is wide (see FIG. 2). The modified quad-tree shown in FIG. 2 is a collection of rectangles (in 2 dimensions, or rectangular boxes higher dimensions) formed by starting with a rectangle that contains the entire set of points on discretized geometry (referred to as the computational box), and recursively dividing the set of boxes according to the modified quad-tree algorithm as described in the U.S. Provisional Patent Application Ser. No. 60/542,666, note that each box is subdivided into only two sub-boxes, and now all boxes at odd-levels are rectangles rather than squares.

The modification of the standard quad-tree structure described herein is referred to as a modified quad-tree.

If a box in a modified quad-tree contains more than s nodes, it is referred to as a parent box; otherwise, it is said to be childless.

A child box is a nonempty box resulting from subdividing a non-empty box into two.

For a square box, colleagues are adjacent boxes of the same size and shape (on the same level). For a rectangular box, colleagues are adjacent square boxes of the same width; in other words, for a rectangular box, the colleagues are of the same size and shape as its sons are or would be (whether it actually has any sons or not).

### Analytical Apparatus

The analytical apparatus (predominantly, from linear algebra) to be used for the construction of the fast algorithm are developed and described herein.

Definition of Scattering Matrices

As used herein, the term “scatterer” shall mean a collection X={x₁,x₂, . . . ,xₙ} of points in R², with F a mapping R²×R²→C; the latter will be referred to as the potential. The notation
F(xᵢ,xₖ)=Fᵢⱼ, (19)
are used herein so that F={Fᵢⱼ} is a complex n×n-matrix. The system of linear equations
F(σ)=f (20)
are referred to as the scattering problem, with f the right-hand side, and σ the induced charge. Whenever F is invertible, induced charge σ will also be referred to as the solution of the scattering problem (20).

For a natural m and a string ΩδΓₙ^{m}, the set X_{Ω}={xᵢ₁,xᵢ₂, . . . ,xᵢₘ}εR² is referred to as a subscatterer of the scatterer X={x₁,x₂, . . . ,xₙ}; the corresponding submatrix of the matrix F will be denoted by F_{Ω}.

It is noted that Ω defines two submatrices of the matrix F: the n×m-submatrix F_{Ω}ⁱⁿ, consisting of columns of F with numbers i₁, i₂, . . . , iₘ, and the m×n-submatrix F_{Ω}^{out}, consisting of rows of F with numbers i₁,i₂, . . . , iₘ. In other words, F_{Ω}ⁱⁿ describes the potential created at the nodes x₁,x₂, . . . ,xₘ by the rest of the scatterer; the matrix F_{Ω}^{out} describes the potential created by the xᵢ₁, xᵢ₂, . . . , xᵢₘ by the nodes xᵢ₁, xᵢ₂, . . . , xᵢₘ on the rest of the scatterer.

Whenever the matrix F_{Ω} is non-singular, the matrix
S_{Ω}=F_{Ω}^{out}∘F_{Ω}⁻¹∘F_{Ω}ⁱⁿ (21)
will be referred to as the scattering matrix corresponding to the subscatterer xᵢ₁, xᵢ₂, . . . , xᵢₘ.

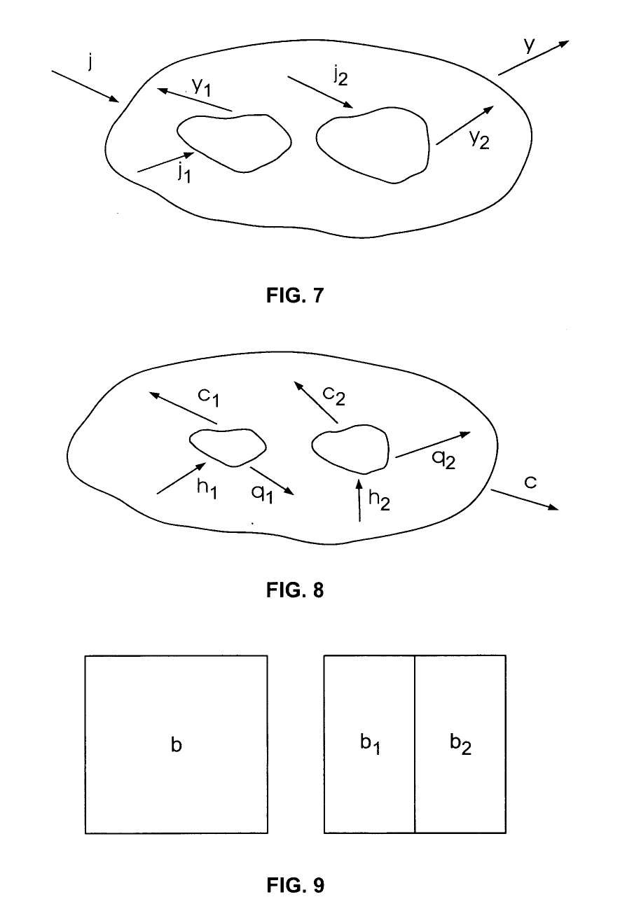

The construction presented here (and in fact the whole structure to be built in this section) is a purely algebraic one, and is independent of the points xᵢ₁, xᵢ₂, . . . , xᵢₘ, and of the nature of the matrix F. The actual construction of the structure is not described since the “physical” interpretation makes it much easier to follow the procedure (see FIGS. 7-8).

Compression of Scattering Matrices

Given a scatterer {x₁,x₂, . . . ,xₙ}, a subscatterer defined by the m-string Ω={i₁,i₂, . . . ,iₘ}, and a reasonable ε>0, it often happens that the ranks of the submatrices F_{Ω}ⁱⁿ, F_{Ω}^{out} are considerably lower than m, to precision ε. In such cases, it becomes advantageous to compress each of these matrices, replacing the submatrices F_{Ω}, F_{Ω}ⁱⁿ, F_{Ω}^{out} rout with matrices of lower dimensionality. The following theorem is an application of Theorem 2.1 to the matrices F_{Ω}ⁱⁿ, F_{Ω}^{out}.

Theorem 3.1: Assume that the scatterer X={x₁,x₂, . . . ,xₙ}, the m-string Ω={i₁,i₂, . . . ,iₘ}, and the real ε>0 are such that
kⁱⁿ=R_{ε}(F_{Ω}ⁱⁿ)≦m, (22)
k^{out}=R_{ε}(F_{Ω}^{out})≦m, (23)
with kᵢₙ, kₒᵤₜ<m. Then there exist two subsets Ωⁱⁿ={s₁ⁱⁿs₂ⁱⁿ, . . . ,sₖⁱⁿⁱⁿ}, Ω^{out}={s₁^{out},s₂^{out}, . . . ,sₖ^{outout}} of Ω and three matrices Ev: C^{kin}→C^{m}, Ex: C^{m}→C^{kout}, S: C^{kin}→C^{kout}, such that
F_{Ω}^{out}=F_{Ω}_{^{out}}^{out}∘Ex, (24)
F_{Ω}ⁱⁿ=Ev∘F_{Ω}_{ⁱⁿ}ⁱⁿ, (2 5)
and
S_{Ω}=F_{Ω}_{^{out}}^{out}∘S∘F_{Ω}_{ⁱⁿ}ⁱⁿ. (26)

The existence of the matrices Ex, Ev satisfying (24), (25) is an immediate consequence of Theorem 2.1. In order to obtain (26), (24), (25) are substituted into (21), obtaining
S_{Ω}=F_{Ω}^{out}∘F_{Ω}⁻¹∘F_{Ω}ⁱⁿ=F_{Ω}_{^{out}}^{out}∘Ex∘F_{Ω}⁻¹∘Ev∘F_{Ω}_{ⁱⁿ}^{in.} (27)

Now, (26) is obtained by defining \tilde{S} via the formula
\overline{S}=Ex∘F_{Ω}⁻¹∘Ev. (28)

For obvious reasons, the subset X_{Ω}^{out} of X_{Ω} will be referred to as the outgoing ε-skeleton of X_{Ω}, or simply the outgoing skeleton of X_{Ω} when there is no danger of confusion. Similarly, the subset X_{Ω}ⁱⁿ of X_{Ω} will be referred to as the incoming ε-skeleton of X_{Ω}, or simply the incoming skeleton of X_{Ω}.

The above theorem has a simple physical interpretation. Specifically, given a discretization of a subscatterer in a scattering structure, it often happens that the ranks kⁱⁿ, k^{out}, of its matrices S_{Ω}ⁱⁿ, S_{Ω}^{out} of interactions with the rest of the structure is considerably lower (to precision ε) than the number of nodes in the discretization of the subscatterer. In such cases, the potential generated by the subscatterer on the rest of the structure can be approximated (to precision ε) by the potential of k^{out} of appropriately chosen nodes, xₛ₁^{out}, xₛ₂^{out}, . . . , xₛₖ^{outout}, with the matrix Ex providing the “expansion” of the potential generated outside X_{Ω} by all nodes in X_{Ω} into a charge distribution at the nodes in X_{Ω}^{out}.

Similarly, the potential generated at all nodes comprising the subscatterer X_{Ω} by the rest of the structure is determined (to precision ε) by the potential generated by the rest of the scatterer at kⁱⁿ appropriately chosen nodes, xₛ₁ⁱⁿ, xₛ₂ⁱⁿ, . . . , xₛₖⁱⁿⁱⁿ, with the matrix Ev providing the “interpolation” of the potential from the nodes xₛ₁ⁱⁿ, xₛ₂ⁱⁿ, . . . , xₛₖⁱⁿⁱⁿ to all m nodes xᵢ₁, xᵢ₂, . . . , xᵢₙ comprising the sub scatterer.

Finally, the scattering matrix S_{Ω} of the subscatterer X_{Ω} can be approximated (to precision ε) by the expression (28), involving only the skeletons of the subscatterer X_{Ω}.

The matrix \tilde{S} will be referred to herein as the compressed scattering matrix of the subscatterer X_{Ω}; when there is no danger of confusion, it will be simply referred to as the scattering matrix of X_{Ω}.

Scattering Matrices and Splitting Matrices

It is clear from the results of the preceding section that, given two subscatterers X₁=X_{Ω1}, X₂=X_{Ω2}, of the scatterer X={x₁,x₂, . . . ,xₙ}, together with their compressed scattering matrices, it should be possible to “merge” these scattering matrices, obtaining the compressed scattering matrix for the subscatterer X_{Ω}=X₁∪X₂=X_{Ω1}∪X_{Ω2}=X_{Ω1}∪_{Ω2}. The principal purpose of this subsection is Theorem (3.3), providing the requisite formula (36).

Additional notations are introduced.

Ω will denote an m-string {i₁,i₂, . . . ,iₘ} with some m≧1.

Ω₁ and Ω₂ will denote an m₁-string {i₁¹,i₂¹, . . . ,iₘ₁¹} and an m₂-string {i₁²,i₂², . . . ,iₘ₂²}, respectively, with m₁+m₂=m.

X_{Ω}ⁱⁿ will denote the incoming ε-skeleton for the scatterer Ω, with Ωⁱⁿ={s₁ⁱⁿ,s₂ⁱⁿ, . . . ,sₖⁱⁿⁱⁿ}.

X_{Ω}^{out} will denote the outgoing ε-skeleton for the scatterer Ω, with Ω^{out}={s₁^{out},s₂^{out}, . . . sₖ^{outout}}.

X_{Ω1}ⁱⁿ will denote the incoming ε-skeleton for the scatterer Ω₁, with Ω₁ⁱⁿ={s₁^{1,in}s₂^{1,in}, . . . sₖ₁^{in1,in}}.

X_{Ω1}^{out} will denote the outgoing ε-skeleton for the scatterer Ω₁, with Ω₁^{out}={s₁^{1,out}s₂^{1,out}, . . . sₖ₁^{out1,out}}.

X_{Ω2}ⁱⁿ will denote the incoming ε-skeleton for the scatterer Ω₂, with Ω₂ⁱⁿ={s₁^{1,out},s₂^{1,oput}, . . . sₗ₁^{in2,in}}.

X_{Ω2}^{out} will denote the outgoing ε-skeleton for the scatterer Ω₂, with Ω₂^{out}={s₁^{2,out},s₂^{2,out}, . . . ,sₖ₂^{out2,out}}.

T₁ will denote the k₁ⁱⁿ×kⁱⁿ-submatrix of the matrix Ev converting the incoming potential from the incoming skeleton of the subscatterer X_{Ω} to the incoming skeleton of the subscatterer X_{Ω1}.

\overline{T}₁ will denote the k^{out}×k₁^{out}-submatrix of the matrix Ex converting the outgoing potential from the outgoing skeleton of the subscatterer X_{Ω1} to the outgoing skeleton of the subscatterer X_{Ω.}

T₂ will denote the k₂ⁱⁿ×kⁱⁿ-submatrix of the matrix Ev, converting the incoming potential from the incoming skeleton of the subscatterer X_{Ω} to the incoming skeleton of the subscatterer X_{Ω2}.

T₂ will denote the k^{out}×k₂^{out}-submatrix of the matrix Ex converting the outgoing potential from the outgoing skeleton of the subscatterer X_{Ω2} to the outgoing skeleton of the subscatterer Xn.

\tilde{S}(a k^{out}×kⁱⁿ-submatrix) will denote the compressed scattering matrix for the subscatterer X_{Ω}.

\tilde{S}₁(a k₁^{out}×k₁ⁱⁿ-submatrix) will denote the compressed scattering matrix for the subscatterer X_{Ω1}.

\tilde{S}₂(a k₂^{out}×k₂ⁱⁿ-submatrix) will denote the compressed scattering matrix for the subscatterer X_{Ω2}.

T₂₁ will denote the k₂ⁱⁿ×k₁^{out}-submatrix of F_{Ω} evaluating on X_{Ω2}ⁱⁿ in the potential of a charge distribution on X_{Ω1}^{out}.

T₁₂ will denote the k₂ⁱⁿ×k₁^{out}-submatrix of F_{Ω} evaluating on X_{Ω1}ⁱⁿ the potential of a charge distribution on X_{Ω2}^{out}.

φ will denote the incoming potential on X_{Ω}, tabulated at the nodes in X_{Ω}ⁱⁿ.

φ will denote the outgoing potential on X_{Ω}, tabulated at the nodes in X_{Ω}^{out}.

φ₁ will denote the incoming potential on X_{Ω1}, tabulated at the nodes in X_{Ω1}ⁱⁿ.

φ₁ will denote the outgoing potential on X_{φ1}, tabulated at the nodes in X_{Ω1}^{out}.

φ₂ will denote the incoming potential on X_{Ω2}, tabulated at the nodes in X_{Ω2}ⁱⁿ.

φ₂ will denote the outgoing potential on X_{φ2}, tabulated at the nodes in X_{Ω2}^{out}.

The lemma below summarizes several identities following immediately from the above definitions.

Lemma 3.2

In the notation introduced above,
φ₁=T₁(φ)+T₁₂(ψ₂), (29)
φ₂=T₂(φ)+T₂₁(ψ₁), (30)
ψ₁=\tilde{S}₁(φ₁), (31)
ψ₂=\tilde{S}₂(φ₂), (32)
ψ=T₁(ψ₁)+T₂(ψ₂). (33)

The following simple theorem (illustrated in FIG. 7) is one of principal numerical tools of the present invention. For a scatterer consisting of two subscatterers, it expresses the compressed scattering matrix for the former via the compressed scattering matrices of the latter. It also provides expressions for the two “splitting” matrices, converting an incoming potential φ impinging on the larger scatterer into the incoming potentials φ₁, φ₂, impinging on each of the two subscatterers, in the presence of the interaction between the subscatterers.

Theorem 3.3: In the notation introduced above, and
φ₁=(I−T₁₂∘\tilde{S}₂∘T₂₁∘\tilde{S}₁)⁻¹∘(T₁+T₁₂∘\tilde{S}₁∘T₁)(φ), (34)
φ₂=(I−T₂₁∘\tilde{S}₁∘T₁₂∘\tilde{S}₂)⁻¹∘(T₂+T₂₁∘\tilde{S}₁∘T₁)(φ), (35)
and
   \tilde{S}=\overline{T}₁∘\tilde{S}₁∘(I−T₁₂)∘S₂∘T21∘S₁)⁻¹∘(T₁+T₁₂∘S₂∘T₂)+\overline{T}₂∘\tilde{S}₂∘(I−T₂₁)∘S₁∘T12∘S₂)⁻¹∘(T₂+T₂₁∘S₁∘T₁). (36)

Substituting identity (31) into identity (29) and identity (32) into identity (30), the following is obtained
φ₁=T₁(φ)+T₁₂∘\tilde{S}₂(φ₂), (37)
φ₂=T₂(φ)+T₂₁∘\tilde{S}₁(φ₁). (38)

Now, substituting (38) into (37),
φ₁=T₁(φ)+T₁₂∘\tilde{S}₂(T₂(φ)+T₂₁∘\tilde{S}₁(φ₁)), (39)
or
   (I−T₁₂∘\tilde{S}₂∘T₂₁∘\tilde{S}₁)(φ₁)=(T₁+T₁₂∘\tilde{S}₂∘T₂)(φ), (40)
   which (obviously) implies (34); exchanging the places of φ₁, φ₂ in the preceding calculation, (35) is obtained.

Now, (36) follows immediately from the combination of (33), (34) with (31)-(33)

Introducing the notation
Spl₁=(I−T₁₂∘\tilde{S}₂∘T₂₁∘\tilde{S}₁)⁻¹∘(T₁+T₁₂∘\tilde{S}₂∘T₂), (41)
Spl₂=(I−T₂₁∘\tilde{S}₁∘T₁₂∘\tilde{S}₂)⁻¹∘(T₂+T₂₁∘\tilde{S}₁∘T₁), (42)
(39), (40) are rewritten in the form
φ₁=Spl₁(φ), (43)
φ₂=Spl₂(φ), (44)
and will (for obvious reasons) refer to the matrices Spl₁, Spl₂ as the splitting matrices.
Merging and Exchange Matrices

Recursive application of Theorem 3.3 of the preceding section is sufficient for the construction of scattering matrices for all subscatterers on all levels. However, while the scattering matrix of a scatterer completely describes its interactions with the outside world, it provides no mechanism for the evaluation of the potential inside the scatterer. The purpose of this subsection is Theorem 3.4, providing the formulae for the construction of the scattered potentials ψ₁, ψ₂ produced by the scatterers X₁, X₂ respectively in the presence of each other.

Throughout herein, for each of the subscatterers X₁=X_{Ω1}, X₂=X_{Ω2} of the scatterer X=X_{Ω}, the restricted scattering problem will be assumed to have been solved. In addition to the notation introduced in the preceding subsection, the following conventions are adopted (see FIG. 8).

χ₁ will denote the outgoing potential on X_{Ω1}, resulting from the solution of the scattering problem on X_{Ω1} in the absence of the rest of the scattering structure.

χ₂ will denote the outgoing potential on X_{Ω2}, resulting from the solution of the scattering problem on X_{Ω2} in the absence of the rest of the scattering structure.

η₁ will denote the incoming potential on X_{Ω1}, resulting from the solution of the scattering problem on the subscatterer X_{Ω}=X_{Ω1} [symbol] X_{Ω2}, i.e. including the effects of the interaction between the subscatterers X_{Ω1}, X_{Ω2}.

η₂ will denote the incoming potential on X_{Ω2}, resulting from the solution of the scattering problem on the subscatterer X_{Ω}=X_{Ω1} [symbol] X_{Ω2}, i.e. including the effects of the interaction between the subscatterers X_{Ω1}, X_{Ω2}.

θ₁ will denote the outgoing potential on X_{Ω1}, resulting from the scattering of the total potential arriving at X_{Ω1} from X_{Ω2}. In other words,
θ₁=\tilde{S}₁(η₁). (45)

θ₂ will denote the outgoing potential on X_{Ω2}, resulting from the scattering of the total potential arriving at X_{Ω2} from X_{Ω1}. In other words,
θ₂\tilde{S}₂(η₂). (46)

χ will denote the outgoing potential on X_{Ω}, resulting from the interaction between the subscatterers X_{Ω2}, X_{Ω1}. In other words, given the two subscatterers X_{Ω2}, X_{Ω1} driven by their respective right-hand sides and generating the induced potentials χ₁, χ₂ respectively in the absence of each other, χ is the total scattered potential generated by these two scatterers when these two scatterers interact with each other. Obviously,
χ=\overline{T}₁(χ₁+θ₁)+\overline{T}₂(χ₂θ₂) (47)

Theorem 3.4 In the notation introduced above,
η₁=(I−T₁₂∘\tilde{S}₂∘T₂₁∘\tilde{S}₁)⁻¹∘T₁₂(χ₂+\tilde{S}₂∘T₂₁(χ₁)), (48)
η₂=(I−T₂₁∘\tilde{S}₁∘T₁₂∘\tilde{S}₂)⁻¹∘T₂₁(χ₁\tilde{S}₁∘T₁₂(χ₂)), (49)
and

$$χ = {T}_{1} ( {χ}_{1} ) + {T}_{2} ( {χ}_{2} ) + ( {\overline{T}}_{1} ∘ {\tilde{S}}_{1} ∘ {( I - {T}_{12} ∘ {\tilde{S}}_{2} ∘ {T}_{21} ∘ {\tilde{S}}_{1} )}^{- 1} ∘ {T}_{12} ∘ {\tilde{S}}_{2} + {\overline{T}}_{2} ∘ {\tilde{S}}_{2} ∘ {( I - {T}_{21} ∘ {\tilde{S}}_{1} ∘ {T}_{12} ∘ {\tilde{S}}_{2} )}^{- 1} ) ∘ {T}_{21} ( {χ}_{1} ) + ( {\overline{T}}_{2} ∘ {\tilde{S}}_{2} ∘ {( I - {T}_{21} ∘ {\tilde{S}}_{1} ∘ {T}_{12} ∘ {\tilde{S}}_{2} )}^{- 1} ∘ {T}_{21} ∘ {\tilde{S}}_{1} + {\overline{T}}_{1} ∘ {\tilde{S}}_{1} ∘ {( I - {T}_{12} ∘ {\tilde{S}}_{2} ∘ {T}_{21} ∘ {\tilde{S}}_{1} )}^{- 1} ) ∘ {T}_{12} ( {χ}_{2} ) \qquad ( 50 )$$

The obvious observation is that
η₁=T₁₂(χ₂+θ₂)=T₁₂(χ₂\tilde{S}₂(η₂)), (51)
η₂=T₂₁(χ₁+θ₁)=T₂₁(χ₁+\tilde{S}₁(η₁)). (52)
Combining (52) with (51) and performing manipulations, the following is obtained
(I−T₁₂∘\tilde{S}₂∘T₂₁β\tilde{S}₁)(η₁)=T₁₂(χ₂+\tilde{S}₂∘T₂₁(χ₁)), (53)
(I−T₂₁∘\tilde{S}₁∘T₁₂∘\tilde{S}₂)(η₂)=T₂₁(χ₁+\tilde{S}₁∘T₁₂(χ₂)), (54)
from which (48), (49) follow immediately.

Introducing the notation
Exchg₁₁=(I−T₁₂∘\tilde{S}₂∘T₂₁∘\tilde{S}₁)⁻¹∘T₁₂∘\tilde{S}₂∘T₂₁, (55)
Exchg₁₂=(I−T₁₂∘\tilde{S}₂∘T₂₁∘\tilde{S}₁)⁻¹∘T₁₂, (56)
Exchg₂₁=(I−T₂₁∘\tilde{S}₁∘T₁₂∘\tilde{S}₂)⁻¹∘T₂₁, (57)
Exchg₂₂=(I−T₂₁∘\tilde{S}₁∘T₁₂∘\tilde{S}₂)⁻¹∘T₂₁circ\tilde{S}₁∘T₁₂, (58)
(48), (49) are rewritten in the form
η₁=Exchg₁₁(χ₁)+Exchg₁₂(χ₂), (59)
η₂=Exchg₂₁(χ₁)+Exchg₂₂(χ₂), (60)
and will (for obvious reasons) refer to the matrices Exchg₁₁, Exchg₁₂, Exchg₂₁, Exchg₂₂ as exchange matrices.

Similarly, introducing the notation

$$\begin{matrix}{M}_{1} = {\overline{T}}_{1} + ( {\overline{T}}_{1} ∘ {\tilde{S}}_{1} ∘ {( I - {T}_{12} ∘ {\tilde{S}}_{2} ∘ {T}_{21} ∘ {\tilde{S}}_{1} )}^{- 1} ∘ {T}_{12} ∘ {\tilde{S}}_{2} + {\overline{T}}_{2} ∘ {\tilde{S}}_{2} ∘ {( I - {T}_{21} ∘ {\tilde{S}}_{1} ∘ {T}_{12} ∘ {\tilde{S}}_{2} )}^{- 1} ) ∘ {T}_{21} , & ( 61 ) \\ {M}_{2} = {\overline{T}}_{2} + ( {\overline{T}}_{2} ∘ {\tilde{S}}_{2} ∘ {( I - {T}_{21} ∘ {\tilde{S}}_{1} ∘ {T}_{12} ∘ {\tilde{S}}_{2} )}^{- 1} ∘ {T}_{21} ∘ {\tilde{S}}_{1} + {\overline{T}}_{1} ∘ {\tilde{S}}_{1} ∘ {( I - {T}_{12} ∘ {\tilde{S}}_{2} ∘ {T}_{21} ∘ {\tilde{S}}_{1} )}^{- 1} ) ∘ {T}_{12} , & ( 62 )\end{matrix}$$

(51) is rewritten in the form
χ=M₁(χ₁)+M₂(χ₂), (63)
and (for obvious reasons) refer to the matrices M₁, M₂ as the merging matrices.

### Description of the Procedure

Application of the Factored Operator to an Arbitrary Vector

The process is started by building a modified quad-tree on top of the scattering structure. The nodes inside each box in the structure are viewed as a separate subscatterer, and the threshold s (the maximum number of nodes in a childless box) is chosen in such a manner that for each childless box, each of the skeletons (incoming and outgoing) consists of all nodes in the box. The following theorem is central to the algorithm of the present invention; its proof is constructive, and will also serve as a description of the procedure for the application of the operator F⁻¹ (see (20)).

Theorem 4.1: Given a scattering problem of the form (20), with the scattering structure organized into a modified quad-tree, the set of scattering, splitting, merging and exchange matrices for all boxes on all levels completely determines the solution of the scattering problem.

As observed above, the proof is purely constructive: starting with a right-hand side f tabulated at all nodes comprising the scatterer (see (20)), Theorems 3.3, 3.4, and Lemma 3.2 are used recursively construct the potentials χ, η, θ, φ, ψ for all boxes on all levels, and to express the solution of the scattering problem (20) via these potentials.

The proof consists of three phases. In the first phase, Theorem 3.3 and Lemma 3.2 are used to construct the potentials χ, η, θ for all boxes on all levels. In the second phase, Theorems 3.4, 3.3 are used to combine the potentials χ, η, θ a into the potentials φ, ψ for all boxes on all levels. Finally, during the third phase, the potentials φ, ψ for each childless box are used to obtain the solution of, ψ at all nodes inside that box, with the help of Lemma 3.2.

Following is a detailed description of the three phases.

Phase 1: Since for childless boxes, the skeletons coincide with the subscatterers themselves, for each childless box b,
χ_{b}=\tilde{S}_{b}(f_{b}); (64)
thus, the construction of potentials χ_{b} for all childless boxes b requires nothing but the scattering matrices \tilde{S}_{b}.

Once the potentials χ_{b1}, χ_{b2} have been constructed for two sons b₁, b₂ of any box b on any level of subdivision, the potentials η_{b1}, η_{b2} can be constructed via the formulae (59), (60); the potentials θ_{b1}, θ_{b2} can be obtained via the formulae (45), (46); and the potential χ_{b} is given by the formula (63). Thus, all potentials χ_{b}, η_{b}, θ_{b} are readily constructed by the recursive procedure starting at the childless boxes and moving up to the computational box itself.

Phase 2: This phase starts with the observation that the potential on the subscatterer inside each box b in the simulation can be separated into two parts: the part χ_{b} induced by the right-hand side f restricted to the nodes inside b in the absence of the rest of the scatterer, and the part resulting from the interactions of b with the rest of the scattering structure. The first part has been accounted for in the Phase 1 above; the second part will be dealt with in this Phase.

First, it is observed that for the whole computational box (refinement level 0), the problem is greatly simplified: the second part of the potential is absent, since no other elements are present in the simulation. Thus, only the next level down need to be considered: two boxes b₁, b₂ on the level 1.

Here, the potentials χ₁, χ₂ have been constructed during Phase 1, and since there are no other nodes in the simulation, the potential η₁ describes the total incoming potential on b₁, and the potential η₂ describes the total incoming potential on b₂.

Suppose now that the box b (on any level) has two sons b₁, b₂, and that the potential φ is coming at from “above” (from the rest of the scattering structure). Obviously, the total potential inside b will consist of the sum of that constructed during Phase 1 with the additional potential induced by φ; now it is observed that the (additional) incoming potentials φ₁, φ₂, induced by φ, on the subscatterers b₁, b₂ are given by (43), (44).

Thus, the splitting process can be conducted recursively, starting at level 1 of refinement, and terminating at the evaluation of incoming potentials on childless boxes.

Phase 3: By the end of the preceding Phase, the potentials φ_{b} for all boxes b, including the childless ones, have been constructed. Obviously, for each childless box b, the solution σ_{b} of the equation (20) is a sum of two parts: the part χ_{b} induced by the right-hand side at the nodes in b (in the absence of the rest of the structure), and the part φ_{b}, induced by the incoming potential φ_{b}. The first part has been constructed in Phase I above (see (64)), and φ_{b} can be calculated via the similar formula
σ_{b}=\tilde{S}_{b}(σ_{b}); (65)
Construction of the Scattering, Splitting, Merging, and Exchange Matrices

A procedure for the solution of the scattering problem (O) was described herein on the assumption that the scattering, merging, splitting, and exchange matrices have been somehow constructed for all boxes on all levels. In this subsection, a brief description of a recursive procedure for the construction of these matrices is described. The procedure comprises three phases. In the first phase, scattering matrices \tilde{S}_{b} are constructed for all childless boxes b via direct inversion of the matrices F_{b}. In the second phase, Theorem 3.3 is used recursively to construct all scattering matrices on all levels of refinement; at the same time, the splitting matrices are constructed. In the third phase, Theorem 3.4 is used to construct the merging and exchange matrices for all boxes on all levels.

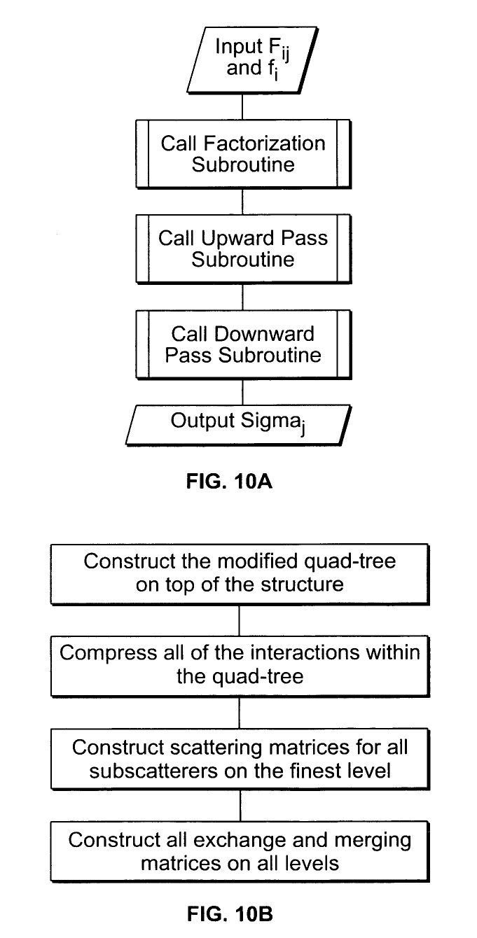

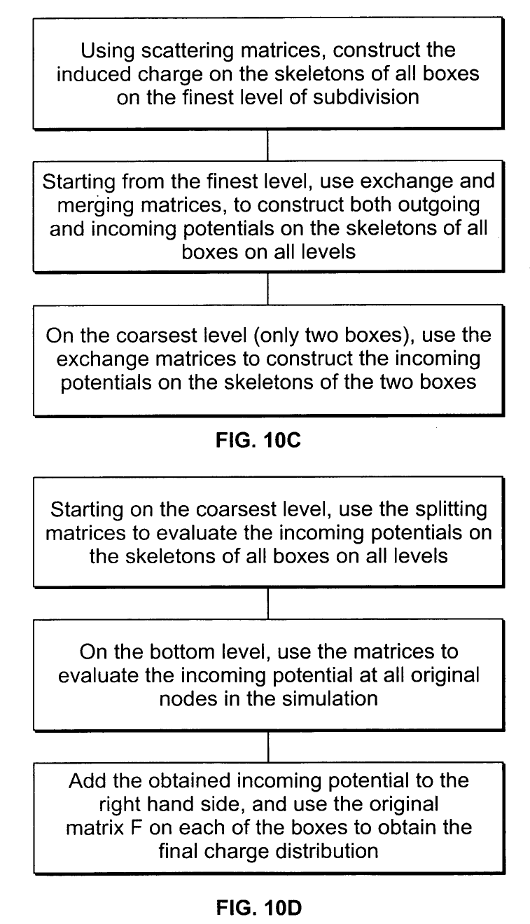

FIGS. 10(A)-(D) and the following is a pseudo-code describing the three steps or phases of the present procedure.

Step 1: Initialization

Comment [Set the maximum number s of the particles in a childless box. Create the computational modified quad-tree.]

```
do l = 0, 1, 2,...
    do b ∈B₁
        if b contains more than s particles then
            subdivide b into two smaller boxes,
            ignore empty boxes, add nonempty boxes to Bₗ₊₁.
        endif
    enddo
enddo
```

Comment [For each childless box b]

```
do l = 0, 1, 2,...
    do b ∈B₁, b is childless
        scattering matrices S_{b}are constructed
        via direct inversion of the matrices F_{b}.
    enddo
enddo
```

Comment [For each childless box b]

```
do l = 0, 1, 2,...
    do b ∈B₁, b is childless
        Form the potentials λ_{b},
        λ_{b} = S_{b}(f_{b});
    enddo
enddo
```

Comment [For each parent box b, construct its skeleton sand associated expansion and evaluation matrices, then form the scattering matrix \tilde{S}_{b} from the scattering matrices of b's children, at the same construct the splitting, merging and exchange matrices for all boxes on all levels.]

```
do l = ..., 2, 1, 0
    do b ∈B₁, b is a parent box
        By using definitions given in main embodiment,
        construct b's skeleton Ω, via the double orthogonalized
        Gram-Schmidt procedure, then, construct T₁, T₂, T₁, T₂,
        T₁₂, T₂₁, acting on the skeletons of b, and its children
        b₁ and b₂.
```

enddo
   enddo

Step 2: Upward Sweep

Comment [For each parent box b, form the potentials η_{b1}, η_{b2} of b's children, and the potential χ_{b}.]
do l= . . . , 2, 1, 0
   do bεBₗ, b is a parent box
      η_{b}_{₁}=Exchg₁₁(χ_{b}_{₁})+Exchg₁₂(χ_{b}_{₂}),
      η_{b}_{₂}=Exchg₂₁(χ_{b}_{₁})+Exchg₂₂(χ_{b}_{₂}),
         η_{b}=M₁(χ_{b}_{₁})+M₂(χ_{b}_{₂}).
   enddo
enddo

Step 2A: Downward Sweep Initialization

Comment [For the top level box b, initialize σ_{b1}, σ_{b2} of b's children.]
do l=0
   do b εB₀
      σ_{b}_{₁}=η_{b}_{₂},
      σ_{b}_{₂}=η_{b}_{₁}.
   enddo
enddo

Step 3: Downward Sweep

Comment [For every parent box b, form the potentials σ_{b1}, σ_{b2} of b's children.]
do l=0, 1, 2, . . .
   do bεB₁, b is a parent box
      σ_{b}_{₁}=Spl₁(σ_{b}),
      σ_{b}_{₂}=Spl₂(σ_{b}),
   enddo
enddo

Step 4: Evaluation

Comment [For each childless box b, evaluate the potential ψ_{b}.]
do l=0, 1, 2, . . .
   do bεB₁, b is childless
      ψ_{b}=\tilde{S}_{b}(σ_{b}).
   enddo
enddo

Comment [Finally, for each childless box b, evaluate the charge density σ_{b}.]
do l=0, 1, 2, . . .
   do bεB₁, b is childless
      σ_{b}=ψ_{b}+ψ_{b}.
   enddo
enddo

### EXAMPLE 1

The boundary value problems of classical potential theory are ubiquitous in engineering and physics. Most such problems can be reduced to boundary integral equations which are, from a mathematically point of view, more tractable than the original differential equations. Although the mathematical benefits of such reformulations were realized and exploited in the 19th century, until recently boundary integral equations were rarely used as numerical tools, since most integral equations upon discretization turn into dense matrices. In the 1980's, the cost of applying dense matrices resulting from potential theory to arbitrary vectors was greatly reduced by the development of “fast” algorithms (Fast Multipole Methods, panel clustering, wavelets, etc.). Combining fast matrix-vector multiplication techniques with iterative schemes for the solution of large-scale systems of linear algebraic equations, it became possible to solve well-conditioned boundary integral equations of potential theory in 0(n) operations, where n is the number of unknowns. Today, such combinations are in many environments the fastest and most accurate numerical solution techniques available.

1. The number of iterations required by an iterative solver is sensitive to the spectral properties of the matrix of the system to be solved; for sufficiently ill-conditioned problems, the number of iterations is proportional to n. Since each iteration (with FMM acceleration) requires O(n) operations, the total operation count is then proportional to n². While this is still better than the O(n³) estimate associated with direct solvers, in many situations O(n²) is not acceptable.

2. When one needs to solve a collection of problems involving a single matrix and multiple right-hand sides, the CPU time requirements of most iterative algorithms are close to the time required to solve one problem multiplied by the number of problems to be solved. With most direct solvers, the situation is different; once the matrix has been inverted (or factored), applying its inverse to each additional right-hand side is very inexpensive.

3. When a collection of linear systems have to be solved whose matrices are in some sense “close” to each other, iterative algorithms derive very little (if any) advantage from the closeness of the matrices.

4. Most direct schemes for the solution of linear systems are closely related to efficient algorithms for the construction of their Singular Value Decompositions and certain other matrix factorizations (L-U, Q-R, etc.). The simplest such scheme is probably the inverse power method with shifts (see, for example, Gene H. Golub and Charles F. Van Loan, Matrix computations, third ed., Johns Hopkins Studies in the Mathematical Sciences, Johns Hopkins University Press, Baltimore, Md., 1996, which is incorporated herein by reference in its entirety), which converts any algorithm for the solution of a linear system into an algorithm for the determination of a prescribed singular value. Iterative techniques do not provide such a capability, except via the so-called Lanczos schemes, which tend to be quite inefficient (see, for example, D. Scott, Analysis of the symmetric lanczos process, Tech. report, University of California at Berkeley, 1978, which is incorporated herein by reference in its entirety).

The present invention is directed to a numerical technique that is intended to overcome these shortcomings by directly producing a compressed (“data-sparse”) factorization of the inverse of the matrix. When applied to contour integral equations of potential theory whose kernels are non-oscillatory, the asymptotic complexity of the solver is typically O(nlog ^{κ}n), where κdepends on the geometry and the kernel (κ=1 or 2). When applied to problems involving oscillatory kernels, the asymptotic complexity deteriorates as the wave-number increases but the scheme remains viable for objects up to a few hundred wavelengths in size. The factorization technique described herein is a multilevel extension of the compression technique described in H. Cheng, Z. Gimbutas, P. G. Martinsson, and V. Rokhlin, On the compression of low rank matrices, Tech. report, Yale University, Dept. of Computer Science, 2003, which is incorporated by reference in its entirety. The machinery underlying these techniques applies generally to matrices with rank-deficient off-diagonal submatrices; contour integral equations have been chosen by the authors simply as the most straightforward application.

A number of researchers have observed that matrices with rank-deficient off-diagonal blocks admit “fast” factorizations (see W. Hackbusch, A sparse matrix arithmetic based on H-matrices. I. Introduction to H-matrices, Computing 62 (1999), no. 2, 89-108 and W. Hackbusch and S. Börm, Data-sparse approximation by adaptive H2-matrices, Computing 69 (2002), no. 1, 1-35, which are incorporated by reference in their entirety); others have constructed “fast” algorithms in various environments (see F. X. Canning and K. Rogivin, Fast direct solution of standard moment-method matrices, IEEE Antennas and Propagation Magazine 40 (1998), 15-26, Yu Chen, A fast, direct algorithm for the Lippmann-Schwinger integral equation in two dimensions, Adv. Comput. Math. 16 (2002), no. 2-3, 175-190, Modeling and computation in optics and electromagnetics, W. C. Chew, An n² algorithm for for the multiple scattering problem of n scatterers, Micro. Optical Tech Letter 2 (1989), 380-383, D. Gines, G. Beylkin, and J. Dunn, LU factorization of non-standard forms and direct multiresolution solvers, Appl. Comput. Harmon. Anal. 5 (1998), no. 2, 156-201, E. Michielssen and A. Boag, A multilevel matrix decomposition algorithm for analysing scattering from large structures, IEEE Trans. Antennas and Propagation 44 (1996), no. 8, 1086-1093, which are incorporated herein by reference in their entirety) where the operators in question posses rank-deficient off-diagonal blocks, without using this property explicitly. In accordance with an embodiment, the algorithm of present invention modifies or improves the algorithm of E. Michielssen, A. Boag, and Chew W. C., Scattering from elongated objects: direct solution in o(n log ²n) operations, IEEE Proc. H 143 (1996), 277-283, which is incorporated by reference in its entirety, that replaces “elongated” objects in two or three dimensions with “curves”, extends the class of kernels addressed by E. Michielssen, A Boag, and Chew W. C., and introduces modifications in the scheme of E. Michielssen, A Boag, and Chew W. C. that are necessary for this extension to work.

The upper case letters are used herein for matrices and lower case letters for vectors and scalars. The canonical unit vectors in Cⁿ are denoted by eⱼ. Given a matrix XεC^{m×n},

$$\begin{matrix}{X}^{*} & denote its adjoint ( the complex conjugate transpose ) , \\ {J}_{k} ( X ) & denote its k \text{-} th singular value , \\ {‖ X ‖}_{2} & denote its {l}^{2} operator norm , \\ {‖ X ‖}_{F} & denote its Frobenius norm , and \\ {{x}_{j}}_{m \times 1} ∈ ℂ & denote its j \text{-} th column .\end{matrix}$$

Given matrices A, B, C and D,

$$[ A B ] , [ \begin{matrix}A \\ C\end{matrix} ] , and [ \begin{matrix}A & B \\ C & D\end{matrix} ] , \qquad ( 2.1 )$$

denote larger matrices obtained by stringing the blocks A, B, C and D together.

Definition 1 (Permutation vectors). Given a positive integer n, Jₙ is define as
Jₙ=the set of permutations of the integers {1, . . . ,n}. (2.2)

Given two integers k and n such that 1≦k≦n, the following is defined as
Jₙ^{k}=the set of subsets of size k of elements of Jₙ. (2.3)

In other words, if JεJₙ^{k}, then J is a vector of integers
J=└j₁, . . . ,jₗ.┘, (2.4)
where 1≦j≦n and all j's are different.

Definition 2 (Submatrix). The term “submatrix” does not imply that the submatrix must form a contiguous block. To be precise, BεC^{k×l} is a submatrix of AεC^{m×n}, if there exist permutations I=[i₁, . . . ,iₖ]εJₘ^{k} and J=[j₁, . . . ,j₁]εJₙ^{l} such that
b_{pq}=aᵢ_{ₚ}ⱼ_{_{q}}, for p=1, . . . , k, q=1, . . . , l. (2.5)

Definition 3 (Neutered rows and columns). Let A be a matrix consisting of p×p blocks,

$$A = [ \begin{matrix}{A}^{( 1 , 1 )} & … & {A}^{( 1 , p )} \\ ⋮ & & ⋮ \\ {A}^{( p , 1 )} & … & {A}^{( p , p )}\end{matrix} ] . \qquad ( 2.6 )$$

The submatrix formed by all blocks on the i-th row are referred to except the diagonal one, i.e.
[A^{(i,1)} . . . A^{i,i-1)}A^{(i,i+1)} . . . A^{i,p)}], 2.7)
as the i-th neutered row of blocks. A neutered column of blocks is defined analogously.

Compression of matrices. In this section, a theorem on matrix compression that forms the foundation of the matrix factorization technique presented herein is described. Roughly speaking, the theorem asserts that given a matrix A of rank k, it is possible to pick k of its columns in such a fashion that they form a well-conditioned basis for the remaining columns. It was first reported in slightly different form in Ming Gu and Stanley C. Eisenstat, Efficient algorithms for computing a strong rank-revealing QR factorization, SIAM J. Sci. Comput. 17 (1996), no. 4, 848-869, which is incorporated herein by reference in its entirety.

Theorem 1. Given an arbitrary matrix A εC^{m×n} and an integer k such that 1≦k<min(m,n), there exists a (not necessarily unique) matrix TεC^{k×(n-l)} and a permutation J=[j₁, . . . ,jₙ]εJₙ such that
Ã₂=Ã₁T+E. (2.8)
Here, Ã₁ and Ã₂ are matrices formed by the columns of A,
Ã₁=[aⱼ_{₁}, . . . ,aⱼ_{ₖ}]εC^{m×k}, (2.9)
Ã₂[aⱼ_{ⱼ₊₁}, . . . ,aⱼ_{ₙ}]εC^{m×(n-k)}, (2.9)
the elements of the matrix TεC^{k×(n-k)} satisfy
|Tᵢⱼ|≦1 for 1≦i≦k, 1≦j≦n−k, (2.10)
and the matrix EεC^{m×(n-k)} satisfies the inequality
∥E∥₂≦σₖ₊₁(A)\sqrt{1+k(n−k)}, (2.11)
where σₖ₊₁(A) is the (k+1)-th singular value of A.

Remark 4 (Computational complexity). While Theorem 1 asserts the theoretical existence of a matrix T and a permutation J with certain properties, it does not address the question of how to determine these numerically. In fact, the authors are not aware of any algorithm that finds these objects in polynomial time. However, in Ming Gu et al., an algorithm is presented that finds a matrix T and a permutation J such that all statements of Theorem 1 still hold, except that (2.10) and (2.11) are replaced by the weaker inequalities
|Tᵢⱼ|≦\sqrt{n}, for 1≦i≦k, 1≦j≦n−k, (2.12)
and
∥E∥₂≦σₖ₊₁(A)\sqrt{1+nk(n−k)}. (2.13)

When m≧n, the computational complexity of this algorithm is typically O(mnk), the same as for the pivoted QR-factorization. In rare cases, the computational complexity may be somewhat larger but it never exceeds O(mn²).

Observation 5 (Column compression). When applied to a matrix AεC^{m×n} of rank k, Theorem 1 asserts that there exists a well-conditioned column operation that leaves k of the columns of A unchanged while mapping the remaining n−k columns to zero. More specifically, let's define

$$R = {P}_{J} [ \begin{matrix}I & - T \\ 0 & I\end{matrix} ] ∈ {ℂ}^{n \times n} , \qquad ( 2.14 )$$

where T and J are defined in Theorem 1 and the permutation matrix Pⱼ is defined by
P_{J}=[eⱼ_{₁}, . . . ,eⱼ_{ₙ}]εC^{n×n}. (2.15)
Then
AR=[A_{CS}0]εC^{m×n}, (2.16)
where the “column skeleton” A_{CS}, is formed by k of the columns of A;
A_{CS}=[aⱼ_{₁}, . . . ,aⱼ_{ₖ}]εC^{m×k}. (2.17)

Moreover, by virtue of (2.10) and the identity

$${R}^{- 1} = ⌊ \begin{matrix}I & T \\ 0 & I\end{matrix} ⌋ {P}_{J}^{*} , \qquad ( 2.18 )$$

it is clear that
∥R∥_{F}≦\sqrt{n+k(n−k)}, and ∥R⁻¹∥_{F}≦\sqrt{n+k(n−k)}. (2.19)

Observation 6 (Row compression). The argument of Observation 5 can equally well be applied to the rows of a matrix AεC^{m×n} of rank k. Thus, there exists a matrix LεR^{m×m} such that

$$LA = [ \begin{matrix}{A}_{RS} \\ 0\end{matrix} ] ∈ {ℂ}^{m \times n} , \qquad ( 2.20 )$$

where the “row skeleton” A_{RS}εC^{k×n} is formed by k of the rows of A and
∥L∥_{F}≦\sqrt{m+k(m−k)}, and ∥L⁻¹∥_{F}≦\sqrt{m+k(m−k)}. (2.21)

### Analytical Apparatus

Consider a p×p block matrix

$$A = [ \begin{matrix}{A}^{( 11 )} & ⋯ & {A}^{( 1 p )} \\ ⋮ & & ⋮ \\ {A}^{( p1 )} & ⋯ & {A}^{( pp )}\end{matrix} ] , \qquad ( 3.1 )$$

such that any neutered row or column of blocks is rank-deficient. In this section compressed factorizations of the inverse of such a matrix is derived. Lemmas 2 and 3 provide factorizations for the case p=2. Observation 8 extends the results of Lemma 3 to a general p. Observation 9 introduces hierarchical factorizations that further improve the efficiency.

Lemma 2 below asserts that for a given 2×2 block matrix with rank-deficient off-diagonal blocks, there exist well-conditioned row- and column-operations that (i) introduce zeros in the off-diagonal blocks and (ii) leave the remaining elements in the off-diagonal blocks untouched.

Lemma 2. Let A be a non-singular matrix

$$A = [ \begin{matrix}{A}^{( 11 )} & {A}^{( 12 )} \\ {A}^{( 21 )} & {A}^{( 22 )}\end{matrix} ] ∈ {ℂ}^{( n + m ) \times ( n + m )} , \qquad ( 3.2 )$$

where A⁽¹¹⁾εC^{n×n}, A⁽²²⁾εC^{m×m} and the offdiagonal blocks A⁽¹²⁾εC^{n×m}, A⁽²¹⁾εC^{m×n} have rank k<min(m, n). Then there exist matrices R,LεC^{n×n} such that

$$[ \begin{matrix}L & 0 \\ 0 & I\end{matrix} ] [ \begin{matrix}{A}^{( 11 )} & {A}^{( 12 )} \\ {A}^{( 21 )} & {A}^{( 22 )}\end{matrix} ] [ \begin{matrix}R & 0 \\ 0 & I\end{matrix} ] = [ \begin{matrix}{X}_{11} & {X}_{12} & {A}_{RS}^{( 12 )} \\ {X}_{21} & {X}_{22} & 0 \\ {A}_{CS}^{( 21 )} & 0 & {A}^{( 22 )}\end{matrix} ] . \qquad ( 3.3 )$$

Here, the matrix A_{RS}⁽¹²⁾εC^{k×m} consists of k of the rows of A⁽¹²⁾ and the matrix A_{CS}⁽²¹⁾εC^{m×k} consists of k of the columns of A⁽²¹⁾. Moreover, X₁₁εC^{k×k}, X₁₂εR^{k×(n-k)}, X₂₁εR^{(n-k)×k}, X₂₂εR^{(n-k)×(n-k)}, and the matrices R and L satisfy (2.19) and (2.21), respectively.

Proof: Due to Observations 5 and 6, there exist matrices R,LεC^{n×n} such that

$${LA}^{( 12 )} = [ \begin{matrix}{A}_{RS}^{( 12 )} \\ 0\end{matrix} ] and {A}^{( 21 )} R = [ \begin{matrix}{A}_{CS}^{( 21 )} & 0\end{matrix} ] , \qquad ( 3.4 )$$

where A_{RS}⁽¹²⁾ and A_{CS}⁽²¹⁾ are submatrices of A⁽¹²⁾ and A⁽²¹⁾, respectively. The identity (3.3) now follows by partitioning

$$L = [ \begin{matrix}{L}_{1} \\ {L}_{2}\end{matrix} ] , where {L}_{1} ∈ {ℂ}^{k \times n} , {L}_{2} ∈ {ℂ}^{( n - k ) \times n} , \\ R = [ \begin{matrix}{R}_{1} & {R}_{2}\end{matrix} ] , where {R}_{1} ∈ {ℂ}^{n \times k} , {R}_{2} ∈ {ℂ}^{n \times ( n - k )} , \qquad ( 3.5 )$$

and setting
X₁₁=L₁A⁽¹¹⁾R₁εC^{k×k},
X₁₂=L₁A⁽¹¹⁾R₂εC^{k×(n-k)},
X₂₁=L₂A⁽¹¹⁾R₁εC^{(n-k)×k},
X₂₂=L₂A⁽¹¹⁾R₂εC^{(n-k)×(n-k)}. (3.6)

The following lemma uses the results of Lemma 3 to reduce the problem of factoring the inverse of the matrix A in (3.2) to the problem of factoring the inverse of the smaller matrix Ã in (3.8).

Lemma 3. Let A, X₁₁, X₁₂, X₂₁, X₂₂, A_{RS}⁽¹²⁾ and A_{CS}⁽²¹⁾ be as in Lemma 2. Provided that the matrix X₂₂ in (3.3) is non-singular, there exist matrices BεC^{n×k}, CεC^{k×n} and DεC^{n×n} such that

$${A}^{- 1} = [ \begin{matrix}B & 0 \\ 0 & I\end{matrix} ] {\tilde{A}}^{- 1} [ \begin{matrix}C & 0 \\ 0 & I\end{matrix} ] + [ \begin{matrix}D & 0 \\ 0 & 0\end{matrix} ] , \qquad ( 3.7 )$$

where

$$\tilde{A} = [ \begin{matrix}{\tilde{A}}^{( 11 )} & {A}_{RS}^{( 12 )} \\ {A}_{CS}^{( 21 )} & {A}^{( 22 )}\end{matrix} ] ∈ {ℂ}^{( k + m ) \times ( k + m )} , \qquad ( 3.8 )$$

and
Ã⁽¹¹⁾=X₁₁−X₁₂X₂₂⁻¹X₂₁εC^{k×k}, (3.9)

Proof: Let L₁, L₂, R₁ and R₂ be defined by (3.5). Inverting both sides of equation (3.3), the identity is obtained

$${A}^{- 1} = [ \begin{matrix}{R}_{1} & {R}_{2} & 0 \\ 0 & 0 & I\end{matrix} ] = {[ \begin{matrix}{X}_{11} & {X}_{12} & {A}_{RS}^{( 12 )} \\ {X}_{21} & {X}_{22} & 0 \\ {A}_{CS}^{( 21 )} & 0 & {A}^{( 22 )}\end{matrix} ]}^{- 1} [ \begin{matrix}{L}_{1} & 0 \\ {L}_{2} & 0 \\ 0 & I\end{matrix} ] . \qquad ( 3.10 )$$

Since X₂₂ is non-singular,

$${[ \begin{matrix}{X}_{11} & {X}_{12} & {A}_{RS}^{( 12 )} \\ {X}_{21} & {X}_{22} & 0 \\ {A}_{CS}^{( 21 )} & 0 & {A}^{( 22 )}\end{matrix} ]}^{- 1} = {[ \begin{matrix}{I}_{k} & 0 \\ - {X}_{22}^{- 1} {X}_{21} & 0 \\ 0 & {I}_{m}\end{matrix} ] \\ [ \begin{matrix}{X}_{11} - {X}_{12} {X}_{22}^{- 1} {X}_{21} & {A}_{RS}^{( 12 )} \\ {A}_{CS}^{( 21 )} & {A}^{( 22 )}\end{matrix} ]}^{- 1} \\ [ \begin{matrix}{I}_{k} & - {X}_{12} {X}_{22}^{- 1} & 0 \\ 0 & 0 & {I}_{m}\end{matrix} ] + [ \begin{matrix}0 & 0 & 0 \\ 0 & {X}_{22}^{- 1} & 0 \\ 0 & 0 & 0\end{matrix} ] . \qquad ( 3.11 )$$

Now (3.7) is obtained by combining (3.10) and (3.11) and setting
B=R₁−R₂X₂₂⁻¹X₂₁εC^{n×k},
C=L₁−X₁₂X₂₂⁻¹L₂εC^{k×n},
D=R₂X₂₂⁻¹L₂εC^{n×n}. (3.12)

Remark 7 (Symmetric factorizations). It is possible to force the factorization (3.7) to be symmetric in the sense that R=L* (which does not imply that C=B* unless A itself is Hermitian). To this end, L and J_{R} are defined as the matrix and index vector that compress the rows of the matrix [A⁽¹²⁾A⁽²¹⁾*]εR^{n×2m} (rather than the rows of A⁽¹²⁾ alone), and set R=L* and J_{C}=J_{R}. This modification typically results in a poorer compression ratio but may dramatically improve the conditioning of the transformation matrices, as discussed in Section 4.4.

Observation 8 (One-level compression of a block matrix). Consider a matrix

$$A = [ \begin{matrix}{A}^{( 11 )} & ⋯ & {A}^{( 1 p )} \\ ⋮ & & ⋮ \\ {A}^{( p1 )} & ⋯ & {A}^{( pp )}\end{matrix} ] ∈ {ℂ}^{pn \times pn} , \qquad ( 3.13 )$$

where A^{(ij)}εC^{n×n} for i,j=1, . . . , p. Assume that any neutered row or column of blocks has rank at most k. Through p applications of Lemma 3, it is possible to reduce the problem of inverting A to the problem of inverting the smaller matrix

$$\tilde{A} = [ \begin{matrix}{\tilde{A}}^{( 11 )} & … & {\tilde{A}}^{( 1 p )} \\ ⋮ & & ⋮ \\ {\tilde{A}}^{( p1 )} & … & {\tilde{A}}^{( pp )}\end{matrix} ] ∈ {ℂ}^{pk \times pk} , \qquad ( 3.14 )$$

where Ã^{(ij)}εC^{k×k} for i,j=1, . . . , p, and Ã^{(ij)} is a submatrix of A^{(ij)} whenever if i≠j.

More specifically, applying Lemma 3 to each of the p diagonal blocks of A, the factorization is obtained

$${A}^{- 1} = [ \begin{matrix}{B}_{1} & 0 & … & 0 \\ 0 & {B}_{2} & & 0 \\ ⋮ & & & ⋮ \\ 0 & 0 & … & {B}_{P}\end{matrix} ] {\tilde{A}}^{- 1} [ \begin{matrix}{C}_{1} & 0 & … & 0 \\ 0 & {G}_{2} & & 0 \\ ⋮ & & & ⋮ \\ 0 & 0 & … & {C}_{P}\end{matrix} ] + [ \begin{matrix}{D}_{1} & 0 & … & 0 \\ 0 & {D}_{2} & & 0 \\ ⋮ & & & ⋮ \\ 0 & 0 & … & {D}_{P}\end{matrix} ] , \qquad ( 3.15 )$$

where BᵢεC^{n×k}, CᵢεC^{k×n} and DᵢεC^{n×n}, for i=1, . . . , p.

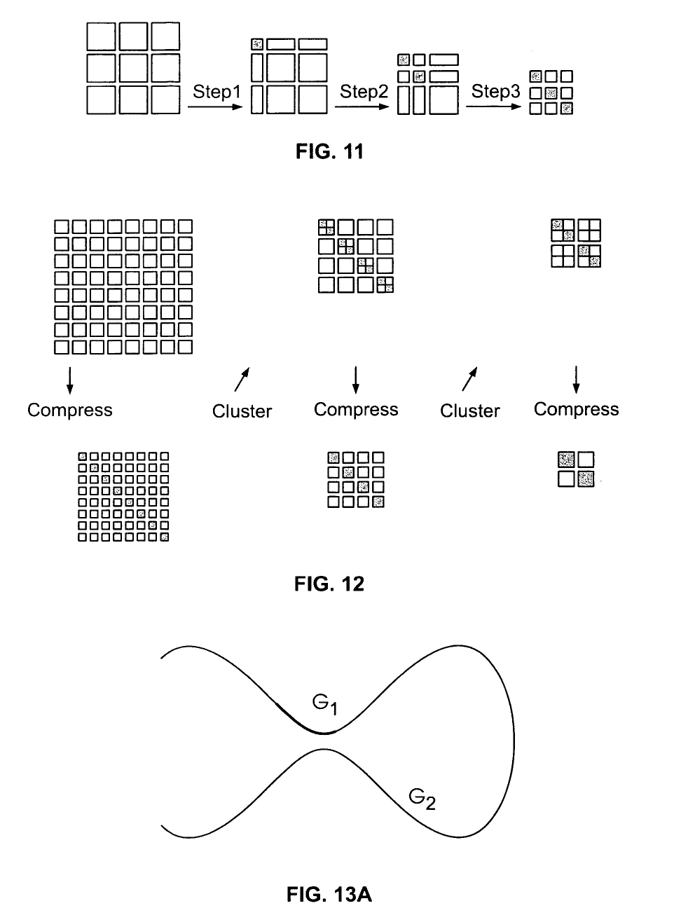

The single-level matrix compression is illustrated graphically in FIG. 11. FIG. 11 is a 3×3 matrix [A^{(ij)}]_{i,j=1}_{³} is compressed in three steps, cf. Observation 8. In step j=1, 2, 3, the single-block compression of Lemma 3 is applied to compress the interaction between A^{(ij)} and the rest of the matrix. Black blocks represents entries that have not been changed beyond row and column permutations and gray represents entries that have been updated but are not (necessarily) zero.

Observation 9 (Hierarchical compression of a block matrix). Observation 8 reduces the problem of inversion of a block matrix with rank-deficient neutered rows and columns to the problem of inversion of a block matrix with smaller blocks. If by clustering these smaller blocks, a matrix with off-diagonal rank-deficiencies is generated, then the process can be repeated recursively to further improve the compression.

More specifically, the notation is changed so that the objects labeled A, Ã and k in Observation 8 are now labeled A⁽¹⁾, Ã⁽¹⁾ and k₁, respectively. Equation (3.15) then reads
(A⁽¹⁾)⁻¹=B⁽¹⁾(Ã⁽¹⁾)⁻¹C⁽¹⁾+D⁽¹⁾, (3.16)
where B⁽¹⁾, C⁽¹⁾, D⁽¹⁾ are block diagonal matrices whose p diagonal blocks are of sizes n×k₁, k₁×n, n×n, respectively. The blocks of the matrix Ã⁽¹⁾ are clustered to form a matrix A⁽²⁾ with (p/2)×(p/2) blocks of size 2k₁×2k₁ and apply the factorization (3.16) to it, thus obtaining a telescoped factorization
(A⁽¹⁾)⁻¹=B⁽¹⁾[B⁽²⁾(Ã⁽²⁾⁾⁻¹C⁽²⁾+D⁽²⁾]C⁽¹⁾+D⁽¹⁾. (3.17)

Here, A⁽²⁾, B⁽²⁾, C⁽²⁾, D⁽²⁾ are all block matrices with (p/2)×p/2) blocks. Letting k₂ denote the rank of the neutered rows and columns of A⁽²⁾, the blocks of Ã⁽²⁾ have size k₂×k₂, while B⁽²⁾, C⁽²⁾, D⁽²⁾ are diagonal block matrices with diagonal blocks of sizes 2k₁×k₂, k₂×2k₁ and 2k₁×2k₁, respectively. This process can be continued until no further clustering is advantageous.

The multi-level matrix compression is illustrated graphically in FIG. 12. FIG. 12 is an 8×8 block matrix is compressed through a three-level compression scheme in the vein of Observation 9. The gray scale coding is the same as in FIG. 11.

Remark 10 (Adjoint of the inverse). Obviously, the factorizations (3.15) and (3.17) provide a mechanism for the accelerated application of both A⁻¹ and [A⁻¹]*.

Remark 11 (Block sizes). In Observations 8 and 9, it was assumed that all blocks within one of the matrices A, Ã, A⁽¹⁾, A⁽²⁾, . . . , have the same size. This assumption was made for notational convenience only and is in no way essential to the results.

### An Algorithm for the Computation of a Compressed Inverse

The existence of a compact factorization of the inverse of any block matrix whose neutered rows and columns of blocks are rank-deficient have been demonstrated in the previous section. In this section, a numerical scheme for the construction of such factorizations, and estimate its efficiency is described.

Remark 12. The inversion scheme presented in this section is fairly generic, depending only on the ranks of off-diagonal blocks of the matrix to be inverted. In situations where the structure of the matrix is known, further improvements are possible. For instance, when applied to a dense n×n matrix resulting from the discretization of a contour integral operator, the generic algorithm of this section requires O(n²) arithmetic operations to construct its inverse, while the customized technique presented herein requires O(nlog ²n) operations or less, depending on the integral operator.

Single block compression. Lemmas 2 and 3 assert that the inverse of a 2×2 block matrix of the form (3.2) can be factored in the compressed form (3.7). The quantities Ã⁽¹¹⁾, R, L, A_{RS}⁽¹²⁾ and A_{CS}⁽²¹⁾ that appear in (3.7) can be determined by taking the following steps:
1. Determine a matrix LεC^{n×n} and a permutation J_{R}εJₙ^{k} such that

$${LA}^{( 12 )} = [ \begin{matrix}{A}_{RS}^{( 12 )} \\ 0\end{matrix} ] ,$$
where A_{RS}⁽¹²⁾ is formed by the k rows of A⁽¹²⁾ specified by J_{R}, as described in Observation 6.
2. Determine a matrix RεC^{n×n} and a permutation J_{c}εJₙ^{k} such that

$${A}^{( 21 )} R = [ {A}_{CS}^{( 21 )} 0 ] ,$$
where A_{CS}⁽²¹⁾ is formed by the columns of A⁽²¹⁾ specified by J_{C}, as described in Observation 5.
3. Partition R and L as specified in (3.5) and form the blocks Xᵢⱼ as in (3.6).
4. Compute Ã⁽¹¹⁾, B, C and D using the formulas (3.9) and (3.12).

Steps (1) and (2) require O(mnk) floating point operations while steps (3) and (4) require O(n³) operations. The total cost is thus O(mnk+n³).

Single-level compression. Let A denote a matrix consisting of p×p blocks, each of size n×n, in which every neutered row or column has rank k such that k<n. Observation 8 states that such a matrix can be factored in the sparse form (3.15). This factorization contains the entities Bᵢ, Cᵢ, Dᵢ, Ã^{(ij)} for i,j=1, . . . ,p, which can be computed through p applications of the single-block compression technique of Section 4.1—one application for each diagonal block. Each one of the p steps requires O(pkn²+n³) floating point operations resulting in a total computational cost of (p²kn²+pn³).

Remark 13. The off-diagonal blocks of the compressed matrix Ã are never explicitly computed. Instead, the block Ã^{(ij)}εC^{k×k} is specified by giving the index vectors J_{R}⁽ⁱ⁾, J_{C}^{(j)}εJₙ^{k} that define the rows and columns of A^{(ij)}εC^{k×k}, whose intersections form Ã^{(ij)}. (Here J_{R}⁽ⁱ⁾ is the index vector obtained when compressing the i-th row of blocks and J_{C}^{(j)} is the index vector obtained when compressing the j-th column of blocks.)

Multi-level compression. The single-level technique compresses a block matrix A to form another block matrix Ã with smaller blocks. Now, if by clustering blocks, the rank-deficiencies in the neutered rows and columns of Ã are generated and the single-level technique can be applied recursively. The algorithmic implementation entirely follows the description in Observation 9.

When estimating the computational cost for the multi-level technique r=1, . . . , R are used as an index for the levels (with r=1 being the finest level), let pᵣ denote the number of blocks on level r, nᵣ the average block size and kᵣ the average rank. The cost for step r is then
tᵣ˜kᵣpᵣ²nᵣ²+pᵣnᵣ³. (4.1)

Assume that pᵣkᵣ≧nᵣ so that the second term is dominated by the first. Using that pᵣkᵣ=pᵣ₊₁nᵣ₊₁, the total cost for all R steps can be determined

$$T \sim {\sum }_{r = 1}^{R} {t}_{r} \sim {\sum }_{r = 1}^{R} {p}_{r} + 1 {p}_{r} {n}_{r} + 1 {n}_{r}^{2} . \qquad ( 4.2 )$$

At each level, the number of blocks is cut in half, so

$${p}_{r} = \frac{p1}{{2}^{r - 1}} . \qquad ( 4.3 )$$

Let ᵣ=nᵣ₊₁/2nᵣ denote the compression ratio so that
nᵣ=(2ᵣ₋₁) . . . (2₁)n₁. (4.4)

Assuming that there exists a constant such that ᵣ≦, the bound is obtained
nᵣ≦(2)^{r-1}n₁. (4.5)

Combining (4.2), (4.3) and (4.5), the total cost is

$$T \sim {\sum }_{r = 1}^{R} \frac{p1}{{2}^{r}} \frac{p1}{{2}^{r - 1}} {( {2}_{} )}^{r} {{n}_{1} ( {2}_{} )}^{2 r - 2} {n}_{1}^{2} \sim {p}_{1}^{2} {n}_{1}^{3} {\sum }_{r = 1}^{R} {( {2}_{3}^{} )}^{r} . \qquad ( 4.6 )$$

Assume < [symbol] \sqrt{4}=0.7937 so that the sum is bounded by (1−2³)⁻¹. Letting N denote the size of the matrix it is found that N=p₁n₁ and thus
T˜N²n₁. (4.7)

The assumption that (4.5) holds for some <0.7939 . . . is valid in many environments relating to discretization of contour integral equations.

Conditioning. All factorizations computed in this section are variations of (3.15). For this formula to be of practical use, the matrices Bᵢ, Cᵢ and Dᵢ must not be excessively large (in say the l² operator norm) and the condition number of Ã has to be similar to that of A. The formulas (3.12) imply that this is true if ∥X₂₂⁻¹∥₂ is of moderate size (since (2.19) and (2.21) assert that R and L are well-conditioned). Under the assumptions of this section (that the global matrix be non-singular and the off-diagonal blocks have low rank) it is not possible to prove any such bound.

However, in the context of contour integral equations, the problem can largely be avoided by enforcing that the compression be symmetric in the sense of Remark 7. The reason is that the diagonal blocks of the original matrix tend to have the form
A⁽¹¹⁾=D+E, (4.8)
where D is a positive definite Hermitian matrix and E is “small” compared to D in operator norm. Since R₂=L₂* when symmetry is enforced, it is found that, cf. (3.6),
   X₂₂=L₂(D+E)L₂=(L₂D^{1/2})(L₂D^{1/2})+L₂EL₂*. (4.9)

Here, the first term is well-conditioned, and the second has at most a few non-small singular values. Thus, it is very unlikely that the sum of the two matrices should have any small singular values. Furthermore, should such a coincidence happen, the algorithm detects it and avoids the problem by locally re-partitioning the matrix.

Error estimation. Given a prescribed accuracy c, the numerical scheme presented in this section solves the equation
Au=f (4.10)
by constructing an approximation A_{ε} that satisfies
∥A−A_{ε}∥₂≦ε (4.11)
and is such that the approximate solution u_{ε}=A_{ε}⁻¹f can be computed fast. The error in u satisfies
u−u_{ε}=(A⁻¹−A_{ε}⁻¹)f=A_{ε}⁻¹(A_{ε}−A)A⁻¹f=A_{ε}⁻¹(A_{ε}−A)u. (4.12)

The relative error is therefore bounded as follows:

$$\frac{‖ u - {u}_{ɛ} ‖}{‖ u ‖} \leq {‖ {A}_{ɛ}^{- 1} ( {A}_{ɛ} - A ) ‖}_{2} \leq ɛ {‖ {A}_{ɛ}^{- 1} ‖}_{2} . \qquad ( 4.13 )$$

While the algorithm cannot possibly control ∥A_{ε}⁻¹∥₂, this quantity can be computed cheaply using power iteration, see Remark 10. Thus, an assured bound for the relative error can be computed à posteriori.

### An Accelerated Algorithm Applicable to Contour Integral Equations

The bulk of the computational cost of the matrix compression technique presented herein consists of the cost of determining index vectors and transformation matrices that compress the neutered rows and columns. When the matrix under consideration is a discrete approximation of a contour integral operator, it is possible to determine these quantities through an entirely local operation whose cost only depends on the size of the diagonal block to be compressed (i.e., not on the size of the rest of the matrix). This is possible since the column and row operations employed in the present matrix compression technique do not update the elements of the off-diagonal blocks, as discussed in Remark 13.

Remark 14 (Numerically rank-deficient matrices). In this section, a matrix has rank k provided that it has only k singular values that are larger than some preset accuracy. In other words, no distinction is made between what is sometimes called “numerical rank” and actual rank.

5.1. Single-block compression. The following observation summarizes the principle finding of this section:

Observation 15. Let the matrix A in (3.2) represent the discretization of the integral operator
∫_{Γ}K(x,y)u(y)ds(y), for xεΓ, (5.1)
where Γ=Γ₁+Γ₂ is a contour (FIG. 3 shows one example), the block structure of A corresponds to the partitioning of Γ (so that, e.g., A⁽¹²⁾ represents evaluation on Γ₁ of the potential generated by a charge distribution on Γ₂), and K is the kernel of a single and/or double layer potential for the Laplace operator. Then under very mild assumptions on the contour Γ, the factorization (3.3) can be computed using O(n³) floating point operations, where n is the number of points used in the discretization of Γ₁.

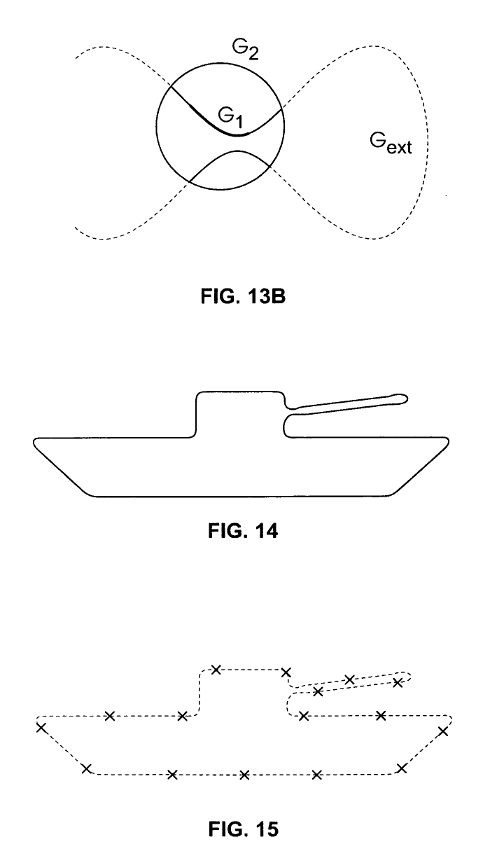

FIGS. 13(a), (b) are contours Γ. In FIG. 13(a), the partitioning Γ=Γ₁+Γ₂ is shown with Γ₁ drawn with a bold line. In FIG. 13(b) the contour \hat{Γ}₂ is drawn with a thin solid line and Γₑₓₜ with a dashed line.

The idea behind the construction alluded to in Observation 15 is simple: Instead of compressing the interaction between Γ₁ and Γ₂, it is sufficient to compress the interaction between Γ₁ and a small contour \hat{Γ}₂, formed by the union of an artificial circular contour enclosing Γ₁ and the part of Γ₂ that is inside this circle (as shown in FIG. 3(b)). The reason is that by virtue of Green's theorem, any potential field generated by charges on Γ₂ can equally well be generated by charges on \hat{Γ}2. Finally it is noted that if Γ₁ is discretized using n nodes, then typically \hat{Γ}₂ can be discretized using O(n) nodes, yielding a total cost for the procedure of O(n³).

The remainder of this subsection is devoted to substantiating Observation 15. Introducing some notation; let Γ_{circ} denote the circle in FIG. 3(b) and let Γₑₓₜ denote the part of Γ₂ outside of Γ_{circ}. Furthermore, let S_{Γ}_{₂}_{-Γ}_{₁} denote the integral operator that evaluates a potential on Γ₁ caused by a charge distribution on Γ₂. In other words, S_{Γ}_{₂}_{-Γ}_{₁} acts on a charge distribution u as follows:
[S_{Γ}_{₂}_{-Γ}_{₁}u](x)=∫_{Γ}_{₂}K(x,y)u(y)ds(y), for xεΓ₁. (5.2)

Observation 15 rests on the following claim:

Lemma 4. Let HεC^{n×n′} denote the matrix discretizing S_{Γ}_{_{circ}}_{-Γ}_{ₗ}, and let the index vector J_{R}εJₙ^{k} and the transformation matrix L be such that they compress H in the sense of Observation 6. Then J_{R} and L also compress the matrix BεC^{n×m} that approximates the operator S_{Γ}_{ₑₓₜ}_{-Γ}ₗ.

Sketch of proof: It is sufficient to prove that there exists a matrix WεC^{n′×m} with moderate l² operator norm such that
B=HW (5.3)

(The matrix W is the matrix that maps a charge distribution on Γₑₓₜ to an equivalent charge distribution on Γ_{circ}.) Now, equation (5.3) is the discrete approximation of the operator relation
S_{Γ}_{ₑₓₜ}_{-Γ}_{₁}=S_{Γ}_{_{circ}}_{-Γ}_{₁}[(S_{Γ}_{_{circ}}_{-Γ}_{_{circ}})⁻¹S_{Γ}_{ₑₓₜ}_{-Γ}_{_{circ}}]. (5.4)

The matrix W in (5.3) corresponds to the operator in square brackets in (5.4). That this operator is bounded is a consequence of Green's theorem.□

Single- and multi-level compression. The generic single- and multi-level compression techniques described herein were obtained by repeated application of the single-block technique described herein. Single- and multi-level techniques for contour integral equations are analogously obtained by repeated application of the single-block technique.

It remains to estimate the computational cost of the accelerated compression technique. The cost for a single level compression at level r=1, . . . , R is now, cf. (4.1),
tᵣ˜pᵣnᵣ³, (5.5)
where p denotes the number of clusters on level r and nᵣ is the (average) cluster size. Under the assumptions (4.3) and (4.5), it is found that

$${t}_{r} \sim \frac{p1}{{2}^{r - 1}} {( {2}_{} )}^{3 r - 3} {n}_{1}^{3} . \qquad ( 5.6 )$$

The total cost for all R steps is then

$$T \sim {\sum }_{r = 1}^{R} {p}_{r} {n}_{r}^{3} \leq {p1n}_{1}^{3} {\sum }_{r = 1}^{R} {( {4}_{3}^{} )}^{r - 1} . \qquad ( 5.7 )$$

We assume that <4^{-1/3}=0.630 . . . so that the sum is bounded by (1−4³)⁻¹. Letting N denote the size of the original matrix, it is found that N=n₁p₁ and thus

$$T \sim {Nn}_{1}^{2} . \qquad ( 5.8 )$$

When the kernel of the equation is associated with the fundamental solution of Laplace's equation, it is possible to prove that the assumption (4.5) holds with ≈½ when n₁≧log N, which gives an upper bound on the computational cost of O(N log ²N). However, further acceleration is achieved by choosing a smaller n₁, even though the cluster size then grows slightly in the first couple of compressions. This explains why the log ²N factor is not visible.

Remark 16. The single-block compression technique described in Observation 15 requires the algorithm to determine which of the nodes of Γ₂ lie inside the artificial circle Γ_{circ}. If this search would be done by brute force, the computational cost for a single level solve would include a term pᵣ²nᵣ², cf. (5.5). Even though the constant in front of this term is small, it would dominate the computation for large problems (in this implementation, this would happen for N≧25000). One solution to this problem is to perform the search via a hierarchical search tree; the estimate (5.5) then remains valid.

5.3. Generalizations. The technique presented herein for Laplace's equation is readily applicable to other equations of classical potential theory; Helmholtz, Yukawa, Shrödinger, Maxwell, Stokes, elasticity, et c. The only complication occurs when working with equations that may have resonances. In such cases, it is possible that the operator of self-interaction for the artificial circle (the operator S_{Γ}_{_{circ}}_{-Γ}_{_{circ}} in (54)) has a non-trivial nullspace. This complication can be rectified by letting the artificial charges on Γ_{circ} consist of both monopoles and dipoles. Alternatively, it is possible to consider only one type of charges but placing them on two concentric circles instead of a single one.

When applied to oscillatory problems such as Helmholtz' and Maxwell's equations, the efficiency of the technique deteriorates when the wave number increases since then the compression rate deteriorates as the blocks grow larger (in other words, the assumption (4.5) no longer holds). In practice, it appears that the method experiences very few problems for objects smaller than about 50 wavelengths. After that, the computational complexity increases superlinearly with the problem size although the technique remains viable for equations set on contours a few hundred wavelengths in size.

Finally it is noted that the scheme has O(nlog ^{κ}n) complexity when applied to integral equations defined on one-dimensional curves in any dimension. The fact that only equations embedded in two space dimensions are discussed so far is simply that contour integral equations associated with boundary value problems in two dimensions is the most common source of such equations.

### NUMERICAL EXAMPLES

The results of a number of numerical experiments performed to assess the efficiency of the numerical scheme are presented herein. In every experimental case, a compressed factorization of the inverse of the matrix is computed resulting from Nyström discretization of one of the following three integral equations:

$$\begin{matrix}\pm \frac{1}{2} u ( x ) + \frac{1}{2 π} {\int }_{Γ} [ n ( y ) \cdot {∇}_{y} log \vert x - y \vert ] u ( y ) ⅆ s ( y ) = f ( x ) , x ∈ Γ , & ( 6.1 ) \\ {\int }_{Γ} [ log \vert x - y \vert ] u ( y ) ⅆ s ( y ) = f ( x ) , x ∈ Γ , & ( 6.2 ) \\ ∓ 2 iu ( x ) + {\int }_{Γ} [ {( n ( y ) \cdot {∇}_{y} + ik )}_{{H}_{0}} ( k \vert x - y \vert ) ] u ( y ) ⅆ s ( y ) = f ( x ) , \\ x ∈ Γ , & ( 6.3 )\end{matrix}$$

where n(y) is the outward pointing unit normal of Γ at y and H₀(x)=J₀(x)+iY₀(x) is the Hankel function of zeroth order. The equations (6.1) and (6.2) are the double and single layer equations associated with Laplace Dirichlet problems, and (6.3) is an equation associated with the Helmholtz Dirichlet problem with wave number k. In equations (6.1) and (6.3), the top sign in front of the first term refers to exterior problems and the lower sign refers to interior problems.

The kernel in (6.1) is smooth and the equation was discretized using the trapezoidal rule (which is exponentially convergent on a smooth contour). The equations (6.2) and (6.3) involve log-singular kernels that were discretized using the modified trapezoidal quadrature rules of S. Kapur and V. Rokhlin, High-order corrected trapezoidal quadrature rules for singular functions, SIAM J. Numer. Anal. 34 (1997), no. 4, 1331-1356, which is incorporated by reference in its entirety, of orders 6 and 10, respectively. The algorithm was implemented in Fortran 77 and the experiments were run on a 2.8 GHz Pentium 4 desktop with 512 Mb of RAM memory.

When presenting the numerical results, the following notations are used:
R the number of levels in the multi-level solver,
Nₛₜₐᵣₜ the size of the discrete problem at the start,
N_{final} the size of the compressed problem,
tₜₒₜ the total CPU time (in seconds),
tₛₒₗᵥₑ the CPU time required to apply the factorized inverse (in seconds),
Cₜₒₚ the condition number of the compressed matrix,
vₘᵢₙ the smallest singular value of the original matrix,
M the amount of memory used (in MB),
E_{actual} the relative error in u, E_{actual}=∥u_{ε}−u∥/∥u∥,
Eᵣₑₛ the relative residual error, Eᵣₑₛ=∥Au_{ε}−f∥/∥f∥,

In each experimental case, the right hand side f was the Dirichlet data corresponding to a potential field generated by a few randomly placed point charges. Since the exact potential field was known, the potential field generated by the numerical solution to the exact one can be compared. The comparison was made at J random points on a circle enclosing Γ and separated from Γ by one quarter of its radius. Letting {v^{(j)}}ⱼ₌₁^{J} denote the exact potential and {v_{ε}^{(f)}}ⱼ₌₁^{J} denote the potential generated by u_{ε}, the relative l²t-norm error in the potential is defined as Eₚₒₜ=∥v−v_{ε}∥/∥v∥.

A smooth contour example is shown in FIG. 14, where the length of the contour is roughly 5.1 and its horizontal width is 2.

In this subsection, the results pertaining to the smooth contour shown in FIG. 14 are described. The contour was discretized using between 800 and 102400 points and the integral equations associated with exterior Dirichlet problems were solved. Tables 1, 2 and 3 present the results for the kernels (6.1), (6.2) and (6.3), respectively. As a reference, the timings for highly optimized implementations of the LU-factorization are given in Table 4, direct matrix-vector multiplication and FMM-accelerated matrix-vector multiplication.

For the two Laplace problems considered, both the computational cost and the memory requirement scale more or less linearly with the problem size, as expected. This expectation was based on the postulate that for Laplace problems, the interaction rank between adjacent clusters depend only very weakly (logarithmically) on their size. FIG. 5 illustrates this point; it shows that after two rounds of compression, almost the only nodes that have survived are the ones near the border to the neighboring clusters. The figure also illustrates that the algorithm detects the need to keep more nodes in the interior of those clusters that run close to other clusters. (For an example of a situation where the equation (6.1) needs to be discretized using a large number of nodes in spite of the fact that the contour is uncomplicated, see P. G. Martinsson, Fast evaluation of electro-static interactions in two phase dielectric media, Tech. report, Yale University, Dept. of Computer Science, 2004, which is incorporated by reference in its entirety.)

Since the scheme presented herein relies on rank-considerations only, it works for oscillatory problems with low wave numbers but it eventually fails as the wavenumber is increased. Table 5 illustrates this point by showing how the compression ratios deteriorate as the wavenumber k in equation (6.3) is increased from 1 to 1200. However, the authors were surprised to find that the method remains viable up to objects about 200 wavelengths across, as indicated in Table 3.

Remark 17 (Comparison with the Fast Multipole Method). From Tables 1 and 4, it is observed that a single FMM matrix-vector multiply is about 15-20 times faster than a matrix inversion. Thus, if an iterative solver requires less than 15-20 iterations to solve equation (6.1), this would beat the direct method for a single solve. However, once the inverse has been computed, it can be applied to additional right hand sides in about one tenth of the time required for a single FMM accelerated matrix-vector multiply.

TABLE 1
Computational results for the double layer potential (6.1) associated with an
exterior Laplace Dirichlet problem on the contour shown in FIG. 14.

| Nₛₜₐᵣₜ | N_{final} | tₜₒₜ | tₛₒₗᵥₑ | E_{actual} | Eᵣₑₛ | Eₚₒₜ | cₜₒₚ | σₘᵢₙ | M |
|---|---|---|---|---|---|---|---|---|---|
| 400 | 301 | 5.3e−01 | 2.9e−03 | 2.3e−10 | 4.7e−10 | 3.0e−06 | 4.3e+00 | 1.3e−02 | 4.2e+00 |
| 800 | 351 | 9.6e−01 | 4.1e−03 | 2.5e−10 | 2.2e−10 | 6.3e−10 | 9.1e+00 | 1.2e−02 | 6.5e+00 |
| 1600 | 391 | 1.6e+00 | 6.3e−03 | 1.4e−10 | 1.3e−10 | 1.6e−10 | 1.6e+01 | 1.2e−02 | 9.2e+00 |
| 3200 | 391 | 1.8e+00 | 8.5e−03 | — | 6.6e−11 | 3.7e−10 | 3.2e+01 | 1.2e−02 | 1.1e+01 |
| 6400 | 391 | 2.2e+00 | 1.2e−02 | — | 5.9e−11 | 8.9e−11 | 7.7e+01 | 1.2e−02 | 1.4e+01 |
| 12800 | 390 | 2.6e+00 | 1.9e−02 | — | 3.6e−11 | 5.9e−11 | 1.4e+02 | 1.2e−02 | 2.1e+01 |
| 25600 | 391 | 3.9e+00 | 3.4e−02 | — | 2.7e−11 | 4.7e−10 | 2.1e+02 | — | 3.5e+01 |
| 51200 | 393 | 6.5e+00 | 6.5e−02 | — | 2.5e−11 | 5.3e−11 | 2.0e+02 | — | 6.3e+01 |
| 102400 | 402 | 1.3e+01 | 1.2e−01 | — | 2.0e−11 | — | 1.1e+03 | — | 1.2e+02 |

TABLE 2
Computational results for the single layer potential (6.2) associated with an
exterior Laplace Dirichlet problem on the contour shown in FIG. 14.

| Nₛₜₐᵣₜ | N_{final} | tₜₒₜ | tₛₒₗᵥₑ | E_{actual} | Eᵣₑₛ | Eₚₒₜ | cₜₒₚ | σₘᵢₙ | M |
|---|---|---|---|---|---|---|---|---|---|
| 400 | 253 | 4.1e−01 | 1.9e−03 | 4.6e−09 | 2.7e−09 | 1.6e−04 | 2.2e+01 | 3.5e−02 | 3.1e+00 |
| 800 | 306 | 8.2e−01 | 3.3e−03 | 7.5e−09 | 9.9e−09 | 2.4e−06 | 1.6e+02 | 2.9e−04 | 5.4e+00 |
| 1600 | 353 | 1.6e+00 | 6.2e−03 | 4.9e−09 | 6.3e−09 | 1.6e−09 | 1.5e+02 | 1.4e−04 | 8.6e+00 |
| 3200 | 369 | 2.3e+00 | 9.7e−03 | — | 2.5e−07 | 1.2e−10 | 2.1e+02 | 4.2e−05 | 1.2e+01 |
| 6400 | 379 | 3.2e+00 | 1.6e−02 | — | 1.3e−08 | 6.8e−12 | 2.6e+02 | 2.1e−05 | 1.8e+01 |
| 12800 | 395 | 4.8e+00 | 2.7e−02 | — | 1.7e−08 | 3.4e−12 | 2.8e+02 | 2.7e−06 | 2.9e+01 |
| 25600 | 409 | 7.7e+00 | 4.8e−02 | — | 3.6e−08 | 1.4e−11 | 3.5e+02 | 2.7e−07 | 5.0e+01 |
| 51200 | 419 | 1.4e+01 | 9.0e−02 | — | 2.7e−07 | — | 3.7e+02 | 3.5e−07 | 9.1e+01 |
| 102400 | 429 | 3.6e+01 | 1.7e−01 | — | 1.6e−08 | — | 5.2e+02 | — | 1.7e+02 |

TABLE 3
Computational results for the kernel (6.3) associated with an exterior Helmholtz
Dirichlet problem on the contour shown in FIG. 14. The Helmholtz parameter was
chosen to keep the number of discretization points per wavelength constant at
roughly 45 points per wavelength (resulting in a quadrature error about 10⁻¹²).
The times in parenthesis refer to experiments that did not fit in RAM.

| k | Nₛₜₐᵣₜ | N_{final} | tₜₒₜ | tₛₒₗᵥₑ | E_{actual} | Eᵣₑₛ | Eₚₒₜ | cₜₒₚ | σₘᵢₙ | M |
|---|---|---|---|---|---|---|---|---|---|---|
| 21 | 800 | 435 | 1.5e+01 | 3.3e−02 | 2.7e−07 | 9.7e−08 | 7.1e−07 | 4.1e+03 | 6.5e−01 | 1.3e+01 |
| 40 | 1600 | 550 | 3.0e+01 | 6.7e−02 | 1.6e−07 | 6.2e−08 | 4.0e−08 | 6.1e+03 | 8.0e−01 | 2.5e+01 |
| 79 | 3200 | 683 | 5.3e+01 | 1.2e−01 | — | 5.3e−08 | 3.8e−08 | 2.1e+04 | 3.4e−01 | 4.5e+01 |
| 158 | 6400 | 870 | 9.2e+01 | 2.0e−01 | — | 3.9e−08 | 2.9e−08 | 4.0e+04 | 3.4e−01 | 8.2e+01 |
| 316 | 12800 | 1179 | 1.8e+02 | 3.9e−01 | — | 2.3e−08 | 2.0e−08 | 4.2e+04 | 3.4e−01 | 1.6e+02 |
| 632 | 25600 | 1753 | 4.3e+02 | 7.5e+00 | — | 1.7e−08 | 1.4e−08 | 9.0e+04 | 3.3e−01 | 3.5e+02 |
| 1264 | 51200 | 2864 | (1.5e+03) | (2.3e+02) | — | 9.5e−09 | — | — | — | 8.3e+02 |

TABLE 4
Timings (in seconds) for highly optimized implementations of the LU-factorization,
matrix-vector multiplication and FMM accelerated matrix-vector multiplication. The
FMM was run at a relative accuracy of 10⁻¹⁰ with the same kernel as in
the equation (6.2). The numbers in parenthesis are extrapolated.

| | N | | | | | | | | |
|---|---|---|---|---|---|---|---|---|---|
| | 400 | 800 | 1600 | 3200 | 6400 | 12800 | 25600 | 51200 | 102400 |
| t_{LU} | 2.8e−02 | 2.0e−01 | 1.6e+00 | 1.3e+01 | (1.0e+02) | (8.3e+02) | (6.7e+03) | (5.3e+04) | (4.3e+05) |
| tₘᵤₗₜ | 7.5e−04 | 2.9e−03 | 1.2e−02 | 4.8e−02 | (1.9e−02) | (7.7e−01) | (3.1e+00) | (1.2e+01) | (4.9e+01) |
| t_{FMM} | 3.8e−03 | 8.0e−03 | 1.6e−02 | 3.0e−02 | 6.0e−02 | 1.2e−01 | 2.4e−01 | 4.8e−01 | 9.6e−01 |

FIG. 15 illustrates the points left after two rounds of compression of the contour shown in FIG. 14. The crosses mark the boundary points between adjacent clusters.

TABLE 5
This table shows to which extent the assumption (4.5) of constant compression
ratios fails for the Helmholtz problem with large wave-numbers. It displays the
compression ratios γⱼ, at each of the levels j = 1, . . . , 8 for the Helmholtz
kernel (6.3) on the smooth contour in FIG. 4, discretized with N = 25600 points.
The three rows correspond to wave numbers k = 1,100,500. The second to
last column shows the number of degrees of freedom left on the finest level
and the last column shows the total memory requirement (in MB).

| k | γ₁ | γ₂ | γ₃ | γ₄ | γ₅ | γ₆ | γ₇ | γ₈ | N_{final} | M |
|---|---|---|---|---|---|---|---|---|---|---|
| 1 | 0.68 | 0.58 | 0.54 | 0.55 | 0.58 | 0.64 | 0.64 | 0.72 | 512 | 167 |
| 100 | 0.72 | 0.56 | 0.55 | 0.56 | 0.60 | 0.68 | 0.72 | 0.82 | 777 | 197 |
| 500 | 0.72 | 0.58 | 0.58 | 0.62 | 0.68 | 0.76 | 0.84 | 0.91 | 1522 | 303 |

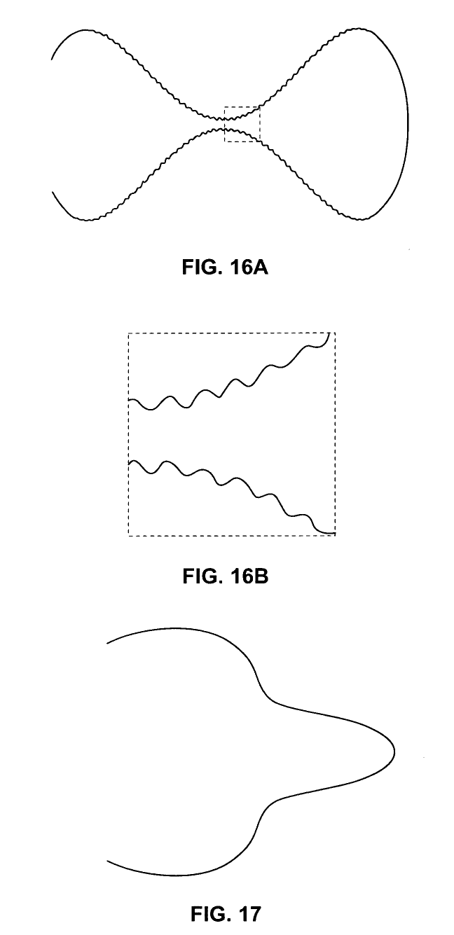

FIG. 16(a) is a rippled contour and FIG. 16(b) is a close-up of the area marked by a dashed rectangle in FIG. 16(a). The horizontal axis of the contour has length 1 and the number of ripples change between the different experiments to keep a constant ratio of 80 discretization nodes per wavelength.

A rippled contour that almost self-intersects. In this subsection, the results pertaining to the rippled contour shown in FIG. 16 are discussed. The contour was discretized using between 800 and 102400 points and integral equations associated with exterior Dirichlet problems were solved. The number of ripples in the experiments increase with the number of discretization nodes in such a fashion that there are roughly 80 nodes for each wavelength. Tables 6, 7 and 8 present the results for the kernels (1), (6.2) and (3), respectively.

The asymptotic complexity of the algorithm remains essentially the same as for the smooth contour shown in FIG. 14. However, the constants involved are larger since more degrees of freedom are required to resolve the contour at the finest levels.

TABLE 6
Computational results for the double layer potential (6.1) associated with an
exterior Laplace Dirichlet problem on the rippled contour shown in FIG. 6.

| Nₛₜₐᵣₜ | N_{final} | tₜₒₜ | tₛₒₗᵥₑ | E_{actual} | Eᵣₑₛ | Eₚₒₜ | cₜₒₚ | σₘᵢₙ | M |
|---|---|---|---|---|---|---|---|---|---|
| 400 | 171 | 2.3e−01 | 1.0e−03 | 1.5e−10 | 1.1e−10 | 1.3e−07 | 7.4e+00 | 1.1e−01 | 1.5e+00 |
| 800 | 228 | 3.5e−01 | 1.0e−02 | 1.9e−10 | 1.3e−10 | 3.8e−08 | 9.7e+00 | 7.6e−02 | 3.0e+00 |
| 1600 | 306 | 7.3e−01 | 5.8e−03 | 1.3e−10 | 1.6e−10 | 5.5e−08 | 1.6e+01 | 5.2e−02 | 6.2e+00 |
| 3200 | 386 | 2.2e+00 | 8.5e−03 | — | 1.4e−10 | 7.5e−08 | 3.1e+01 | 3.9e−02 | 1.2e+01 |
| 6400 | 460 | 4.4e+00 | 1.7e−02 | — | 7.2e−11 | 8.2e−08 | 7.0e+01 | 3.3e−02 | 2.1e+01 |
| 12800 | 536 | 9.6e+00 | 3.5e−02 | — | 5.9e−11 | 3.7e−08 | 1.4e+02 | 2.9e−02 | 4.0e+01 |
| 25600 | 597 | 2.0e+01 | 7.6e−02 | — | 2.0e−11 | 1.4e−09 | 2.2e+02 | — | 7.6e+01 |
| 51200 | 641 | 4.0e+01 | 1.5e−01 | — | 2.9e−11 | — | 6.2e+02 | — | 1.5e+02 |
| 102400 | 688 | (1.8e+01) | 3.9e−01 | — | 1.2e−11 | — | 7.8e+02 | — | 2.9e+02 |

TABLE 7
Computational results for the single layer potential (6.2) associated with an
exterior Laplace Dirichlet problem on the rippled contour shown in FIG. 6.

| Nₛₜₐᵣₜ | N_{final} | tₜₒₜ | tₛₒₗᵥₑ | E_{actual} | Eᵣₑₛ | Eₚₒₜ | cₜₒₚ | σₘᵢₙ | M |
|---|---|---|---|---|---|---|---|---|---|
| 400 | 176 | 2.4e−01 | 9.2e−04 | 2.1e−09 | 1.7e−09 | 2.4e−05 | 1.6e+02 | 5.5e−04 | 1.6e+00 |
| 800 | 220 | 3.9e−01 | 3.8e−03 | 1.6e−08 | 3.0e−08 | 8.0e−06 | 1.1e+03 | 1.0e−05 | 3.1e+00 |
| 1600 | 256 | 6.9e−01 | 5.3e−03 | 5.2e−09 | 7.0e−09 | 9.8e−08 | 2.8e+02 | 1.6e−05 | 5.3e+00 |
| 3200 | 286 | 1.3e+00 | 7.6e−03 | — | 7.0e−09 | 1.6e−08 | 3.3e+02 | 1.2e−05 | 9.1e+00 |
| 6400 | 314 | 2.5e+00 | 1.4e−02 | — | 1.5e−07 | 2.3e−09 | 7.5e+02 | 2.1e−06 | 1.6e+01 |
| 12800 | 342 | 4.6e+00 | 2.8e−02 | — | 2.4e−08 | 1.5e−09 | 4.7e+02 | 1.7e−07 | 2.9e+01 |
| 25600 | 362 | 8.8e+00 | 6.2e−02 | — | 2.3e−08 | 2.2e−09 | 1.1e+03 | 9.7e−08 | 5.5e+01 |
| 51200 | 374 | 1.7e+01 | 1.2e−01 | — | 2.1e−08 | — | 1.8e+03 | 3.1e−08 | 1.1e+02 |
| 102400 | 386 | (8.1e+0) | 2.3e−01 | — | 1.5e−07 | — | 3.1e+03 | — | 2.1e+02 |

TABLE 8
Computational results for the kernel (6.3) associated with an exterior Helmholtz
Dirichlet problem on the rippled contour shown in FIG. 6. The Helmholtz parameter
k was chosen to keep the number of discretization points per wavelength constant
at roughly 55 points per wavelength (resulting in a quadrature error about 10⁻¹²).
The times in parenthesis refer to experiments that did not fit in RAM.

| k | Nₛₜₐᵣₜ | N_{final} | tₜₒₜ | tₛₒₗᵥₑ | E_{actual} | Eᵣₑₛ | Eₚₒₜ | cₜₒₚ | σₘᵢₙ | M |
|---|---|---|---|---|---|---|---|---|---|---|
| 7 | 400 | 224 | 2.9e+00 | 9.0e−03 | 1.4e−07 | 6.9e−08 | 9.4e−07 | 1.2e+04 | 7.9e−01 | 3.2e+00 |
| 15 | 800 | 320 | 7.7e+00 | 1.9e−02 | 1.6e−07 | 7.4e−08 | 1.2e−07 | 3.9e+03 | 7.9e−01 | 8.2e+00 |
| 29 | 1600 | 470 | 2.1e+01 | 4.6e−02 | — | 6.7e−08 | 8.1e−08 | 7.4e+03 | 7.8e−01 | 2.0e+01 |
| 58 | 3200 | 704 | 6.1e+01 | 1.1e−01 | — | 5.2e−08 | 6.4e−08 | 1.2e+04 | 8.0e−01 | 5.0e+01 |
| 115 | 6400 | 1122 | 1.4e+02 | 2.9e−01 | — | 4.8e−08 | 7.5e−08 | 1.4e+04 | 8.0e−01 | 1.3e+02 |
| 230 | 12800 | 1900 | (4.7e+02) | (2.5e+01) | — | 5.5e−08 | 7.5e−08 | 8.8e+04 | 8.0e−01 | 3.4e+02 |
| 461 | 25600 | 3398 | — | — | — | — | — | — | — | 9.8e+02 |

FIG. 17 is a contour the shape of a smooth pentagram. Its diameter is 2.5 and its length is roughly 8.3.

An interior problem close to a resonance. In this section, the results pertaining to interior Dirichlet problem on the contour shown in FIG. 7 is discussed. While interior and exterior Laplace Dirichlet problems are quite similar in nature, the corresponding Helmholtz Dirichlet problems are fundamentally different in that the interior problem possesses resonances while the exterior does not. Hence, the focus has been exclusively on interior Helmholtz problems.

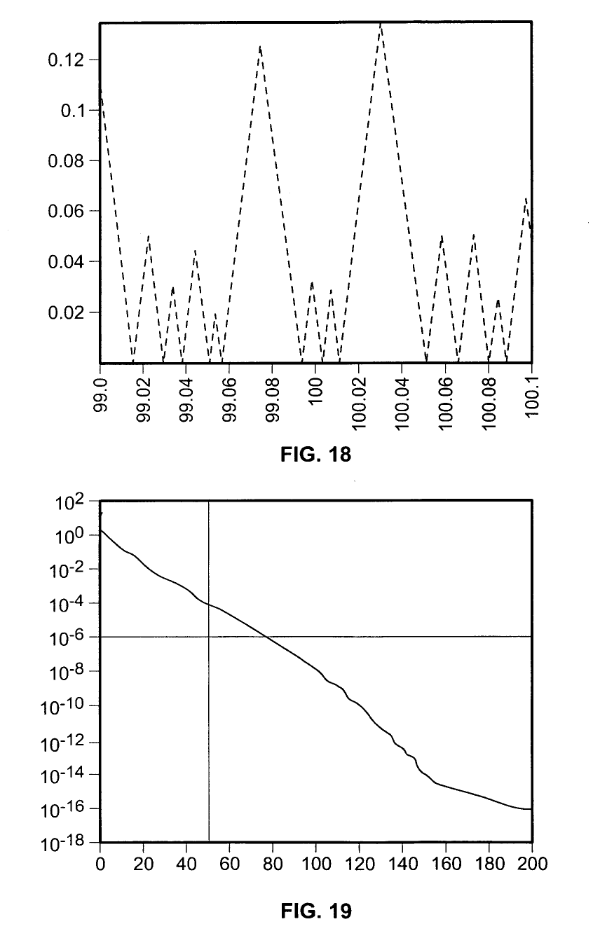

The results of two computational experiments, both relating to the Helmholtz kernel (6.3) are discussed. In the first experiment, a range of wave numbers k between 99.9 and 100.1 was scanned. For each wave number, the smallest singular value 0 min of the integral operator was computed using the iteration technique described herein. The resulting graph of σₘᵢₙ versus k, shown in FIG. 18, clearly indicates the location of each ce in this interval. The second experiment consists of factoring the inverse of the matrix corresponding to k=100.0110276 . . . for which σₘᵢₙ=0.00001366 . . . The results, shown in Table 9, illustrate that the method does not experience any difficulty in factoring the inverse of an ill-conditioned matrix. In particular, the table shows that the factorization matrices B^{(j)}, C^{(f)} and D^{(j)}, see (3.17), are well-conditioned.

FIG. 18 is a plot of σₘᵢₙ versus k for an interior Helmholtz problem on the contour shown in FIG. 17. The values shown were computed using the iteration technique of Section 4.5 applied to a matrix of size N=6400. Each point in the graph required about 60 seconds of CPU time.

TABLE 9
Details of the computation for the Helmholtz kernel (6.3) associated
with an interior Dirichlet problem on the smooth pentagram shown
in FIG. 7 for the case N = 6400 and k = 100.011027569 . . .
For each level j, the table shows the number of clusters pⱼ on that
level, the average size of a cluster nⱼ, the compression ratio γⱼ,
the time required for the factorization tⱼ and the size of the matrices
B^{(j)}, C^{(j)} and D^{(j)} (see (3.17)) in the maximum norm. For this
computation, Eᵣₑₛ = 2.8 · 10⁻¹⁰,
Eₚₒₜ = 3.3 · 10⁻⁵ and σₘᵢₙ = 1.4 · 10⁻⁵.

| j | pⱼ | nⱼ | γⱼ | tⱼ | ∥C^{(j)}∥∞ | ∥B^{(j)}∥∞ | ∥D^{(j)}∥∞ |
|---|---|---|---|---|---|---|---|
| 1 | 128 | 50.00 | 0.76 | 15.50 | 1.12e+00 | 1.12e+00 | 4.20e−02 |
| 2 | 64 | 76.00 | 0.59 | 14.32 | 3.27e+01 | 3.27e+01 | 1.75e+00 |
| 3 | 32 | 89.72 | 0.60 | 8.94 | 1.63e+01 | 1.62e+01 | 9.28e−01 |
| 4 | 16 | 107.00 | 0.64 | 6.27 | 9.09e+00 | 9.17e+00 | 2.41e+00 |
| 5 | 8 | 138.00 | 0.72 | 5.97 | 7.32e+00 | 7.31e+00 | 3.64e+00 |
| 6 | 4 | 199.50 | 0.80 | 7.76 | 3.22e+00 | 3.23e+00 | 3.86e+00 |

FIG. 19 is a star-fish lattice contour; the physical distance between two random points on the contour is not well predicted by their distance along the contour.

A contour resembling an area integral. The final numerical experiment is included to demonstrate that the efficiency of the factorization scheme deteriorates when it is applied to a curve for which the physical distance between two random points on the contour is not well predicted by their physical separation. One example of such a curve is the star-fish lattice illustrated in FIG. 19. Focusing on the double layer Laplace problem (6.1), the factorization scheme is applied to a matrix of size N=25600 and compare the performance to that for the rippled dumb-bell shown in FIG. 16. Table 10 shows that the factorization of the matrix related to the starfish lattice took almost five times as long and resulted in a compressed matrix of over twice the size.

To understand the difference in performance between the different contours, how the interaction rank of a cluster depends on its size was considered. For the contours shown in FIGS. 14, 16 and 17, the rank of the interaction between a cluster of size m and the rest of the contour is effectively bounded by log m. However, for the contour shown in FIG. 19 the corresponding bound is \sqrt{m}. FIGS. 15 and 10 illustrate the difference. Thus, the asymptotic complexity of the scheme when applied to a contour similar to the star-fish lattice is O(n^{3/2}) rather than O(nlog n).

TABLE 10
Test results for two experiments concerning the matrix obtained by
discretizing the double layer Laplace problem (6.1). One involved
the rippled dumb-bell shown in FIG. 16 and the other the star-fish
lattice shown in FIG. 19.

| Contour: | tₜₒₜ | Nₛₜₐᵣₜ | N_{final} | M |
|---|---|---|---|---|
| Rippled dumb-bell | 37 s | 25600 | 559 | 86 Mb |
| Star-fish lattice | 172 s | 25600 | 1202 | 210 Mb |

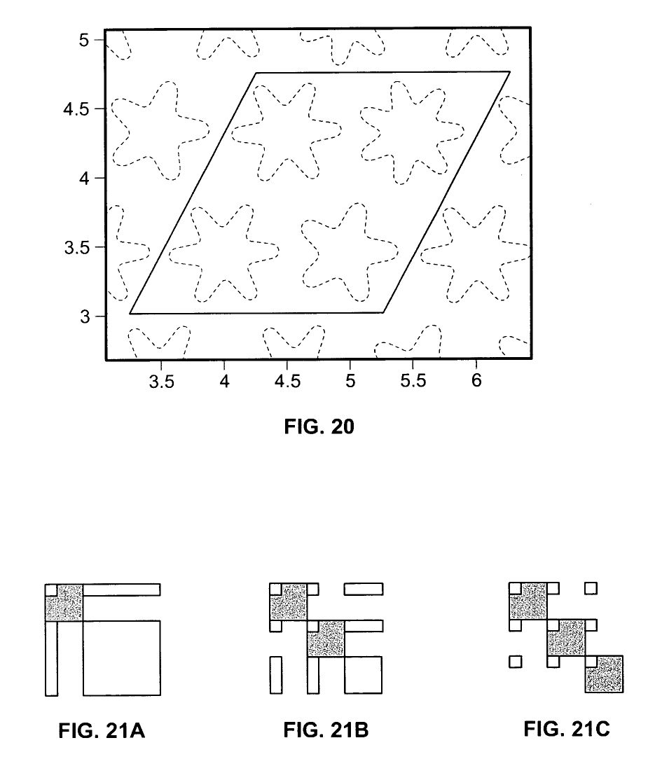

FIG. 20(a) shows a close-up of the star-fish lattice of FIG. 19 and FIG. 20(b) shows the nodes remaining after the interaction between the cluster formed by the points inside the parallelogram and the remainder of the contour has been compressed, cf. FIG. 15.

### Generalizations and Conclusions

A numerical scheme that constructs a compressed factorization of the inverse of a matrix have been described. The scheme is applicable to generic matrices whose off-diagonal blocks have rank-deficiencies but is most efficient when applied to matrices arising from the discretization of integral equations defined on one-dimensional contours. (Although such integral equations frequently arise in the analysis of boundary value problems in two dimensions, the dimension of the underlying space is of little relevance to the algorithm.) For equations with non-oscillatory kernels the computational complexity of the algorithm is O(nlog ^{κ}n) for most contours, where κ=1 or 2, and n is the number of nodes in the discretization of the contour.

Comparing the present implementations of the direct factorization scheme on the one hand and the FMM matrix-vector multiplication scheme on the other, it is observed (i) that in a typical environment, the cost of constructing a factorization of the inverse is 15-20 times larger than the cost of a single FMM matrix-vector multiply, and (ii) that once the factorization of the inverse has been computed, the cost to apply it to a vector is 5-10 times smaller than the cost of a single FMM matrix-vector multiply. Thus, if an iterative solver requires less than 20 steps to converge, the iterative solver outperforms the direct solver for a single solve. However, if multiple right-hand sides are involved, the direct solver has a clear advantage. This observation is the foundation for [11].

Since the scheme is based on rank considerations only, it cannot work for boundary integral equations involving highly oscillatory kernels. However, since the interaction ranks are determined dynamically, the oscillation must be quite significant before the scheme becomes impracticable. Empirically, it was found that the scheme remains efficient for contours a couple of hundred wavelengths in size.

Another limitation of the scheme is that it does not achieve optimal efficiency when applied to a boundary integral equation set on either a contour similar to the one shown in FIG. 19, or on a two-dimensional surface. In either case, its computational complexity is O(n^{3/2}). Overcoming this limitation is a subject of on-going research.

Finally, it is appreciated that the matrix factorization scheme presented herein can be modified to construct certain standard matrix factorizations (such as the singular value decomposition).

### EXAMPLE 2

In computational physics (and many other areas), one often encounters matrices whose ranks are (to high precision) much lower than their dimensionalities; even more frequently, one is confronted with matrices posessing large submatrices that are of low rank. An obvious source of such matrices is the potential theory, where discretization of integral equations almost always results in matrices of this type. Such matrices are also encountered in fluid dynamics, numerical simulation of electromagnetic phenomena, structural mechanics, multivariate statistics etc. In such cases, one is tempted to “compress” the matrices in question, so that they could be efficiently applied to arbitrary vectors; compression also facilitates the storage and any other manipulation of such matrices that might be desirable.

At this time, several classes of algorithms exist that use this observation. The so-called Fast Multipole Methods (FMMs) are algorithms for the application of certain classes of matrices to arbitrary vectors; FMMs tend to be extremely efficient, but are only applicable to very narrow classes of operators (see G. Beylkin, On multiresolution methods in numerical analysis, Documenta Mathematica, Extra Volume ICM 1998, III, pp. 481-490, 1998, which is incorporated herein by reference in its entirety). Another approach to the compression of operators is based on the wavelets and related structures (see, for example, B. Alpert, G. Beylkin, R. Coifinan, V. Rokhlin, Wavelet-like bases for the fast solution of second-kind integral equations, SIAM J. Sci. Comput., vol. 14, pp. 159-184, 1993 and G. Beylkin, R. Coifinan, and V. Rokhlin, Fast wavelet transforms and numerical algorithms I, Communications on Pure and Applied Mathematics, 14:141-183 (1991), which are incorporated by reference in their entirety); these schemes exploit the smoothness of the elements of the matrix viewed as a function of their indices, and tend to fail for highly oscillatory operators.

Finally, there is a class of compression schemes that are based purely on linear algebra, and are completely insensitive the the analytical origin of the operator. It consists of the Singular Value Decomposition (SVD), the so-called QR and QLP factorizations G. W. Stewart, Matrix Algorithms, Vol. I, SIAM, Philadelphia 1998, which is incorporated by reference in its entirety, and several others. Given an m×n-matrix A of rank k<min(m,n), the SVD represents A in the form
A=U◯D∘V, (1.1)
with U an m×k, matrix whose columns are orthonormal, V a k×n matrix whose rows are orthonormal, and D a diagonal matrix whose diagonal elements are positive. The compression provided by the SVD is perfect in terms of accuracy (see, for example, G.H. Golub, C. F. Van Loan, Matrix Computations, Johns Hopkins University Press, 1989, which is incorporated by reference in its entirety), and has a simple geometric interpretation: it expresses each of the columns of A as a linear combination of the k (orthonormal) columns of U; it also represents the rows of A as linear combinations of (orthonormal) rows of V; and the matrices U,V are chosen in such a manner that the rows of U are images (up to a scaling) under A of the columns of V.

Herein a different matrix decomposition is proposed. Specifically, the matrix A described above in the form is represented by
A=U∘B∘V, (1.2)
where B is a k×k-submatrix of A, and the norms of the matrices U,V (of dimensionalities n×k, k×m respectively) are reasonably close to 1 (see Theorem 3 below). Furthermore, each of the matrices U, V contains a unity k×k submatrix.

Like (1.1), the representation (1.2) has a simple geometric interpretation: it expresses each of the columns of A as a linear combination of k selected columns of A, and each of the rows of A as a linear combination of k selected rows of A. This selection defines a k×k submatrix B of A, and in the resulting system of coordinates, the action of A is represented by the action of its submatrix B.

The representation (1.2) has the advantage that the bases used for the representation of the mapping A consists of the columns and rows of A, while each of the elements of the bases in the representation (1.1) is itself a linear combination of all rows (or columns) of the matrix A. Herein, the advantages of the representation (1.2) is illustrated by constructing an accelerated direct solver for integral equations of potential theory.

Another advantage of the representation (1.2) is that the numerical procedure for constructing it is considerably less expensive than that for the construction of the SVD, and that the cost of applying (1.2) to an arbitrary vector is
(n+m−k)·k, (1.3)
vs.
(n+m)·k (1.4)
for the SVD.

The obvious disadvantage of (1.2) vis-a-vis (1.1) is the fact that the norms of the the matrices U, V are somewhat greater than 1, leading to some (though minor) loss of accuracy. Another disadvantage of the proposed factorization is its non-uniqueness; in this respect it is similar to the pivoted QR factorization.

Remark 1. In (1.2), the submatrix B of the matrix A is defined as the intersection of k columns with k rows. Denoting the sequence numbers of the rows by i₁, i₂, . . . , iₖ and the sequence numbers of the columns by j₁, j₂, . . . , jₖ, the submatrix B of A is referred to as the skeleton of A, to the k×n matrix consisting of the rows of A numbered i as the row skeleton of A, and to the m×k matrix consisting of the columns of A numbered j₁, j₂, . . . , jₖ as the column skeleton of A.

### Preliminaries

A notation is introduced and several facts are summarized s from numerical linear algebra; these can all be found in Ming Gu and Stanley C. Eisenstat, Efficient algorithms for computing a strong rank-revealing QR factorization, SIAM J. Sci. Comput. 17 (1996), no. 4, 848-869, incorporated by reference in its entirety.

Herein, upper case letters are used for matrices and lower case letters for vectors and scalars. Q is reserved for matrices that have orthonormal columns and P for permutation matrices. The canonical unit vectors in Cⁿ are denoted by eⱼ. Given a matrix X, let X* denote its adjoint (the complex conjugate transpose), σₖ(X) its k-th singular value, ∥X∥₂ its l²-norm and ∥X∥_{F} its Frobenius norm. Finally, given matrices A, B, C and D let

$$[ A \vert B ] , ⌊ \frac{A}{C} ⌋ , and ⌊ \begin{matrix}A & B \\ C & D\end{matrix} ⌋ , \qquad ( 2.1 )$$

denote larger matrices obtained by stringing the blocks A, B, C and D together.

The first result appears to assert that given any matrix A, it is possible to reorder its columns to form a matrix AP, where P is a permutation matrix, with the following property: When AP is factorized into an orthonormal matrix Q and an upper triangular matrix R, so that AP=QR, then the singular values of the leading k×k submatrix of R are reasonably good approximations of the first k singular values of A. The theorem also says that the first k columns of AP form a well-conditioned basis for the column space of A to within accuracy σₖ₊₁(A).

Theorem 1. [Gu & Eisenstat] Suppose that A is an m×n matrix, l=min(m,n), and k is an integer such that 1≦k≦1. Then there exists a factorization
AP=QR, (2.2)
where P is an n×n permutation matrix, Q is an m×l matrix with orthonormal columns, and R is an l×n upper triangular matrix. Furthermore, splitting Q and R,

$$Q = ⌊ \begin{matrix}{Q}_{11} & {Q}_{12} \\ {Q}_{21} & {Q}_{22}\end{matrix} ⌋ , and R = ⌊ \begin{matrix}{R}_{11} & {R}_{12} \\ 0 & {R}_{22}\end{matrix} ⌋ , \qquad ( 2.3 )$$

in such a fashion that Q₁₁ and R₁₁ are of size k×k, Q₂₁ is (m−k)×k, Q₁₂ is k×(l−k), Q₂₂ is (m−k)×(l−k), R₁₂ is k×(n−k) and R₂₂ is (l−k)×(n−k), results in the following inequalities:

$${‖ A - ⌊ \frac{{Q}_{11}}{{Q}_{21}} ⌋ [ {R}_{11} \vert {R}_{12} ] {P}^{*} ‖}_{2} \leq ɛ \sqrt{1 + k ( n - k )} . \qquad ( 2.7 )$$

σ₁(R₂₂)≦σₖ₊₁(A)\sqrt{1+k(n−k)}, (2.5)
and
|R₁₁⁻¹R₁₂∥_{F}≦\sqrt{k(n−k)}. (2.6)

Remark 2. The full power of Theorem 1 is not used for very small ε=σₖ₊₁(A). In this case, the inequality (2.5) implies that A can be well approximated by a low-rank matrix. In particular, (2.5) implies that

$${σ}_{k} ( {R}_{11} ) \geq {σ}_{k} ( A ) \frac{1}{\sqrt{1 + k ( n - k )}} , \qquad ( 2.4 )$$

Furthermore, the inequality (2.6) in this case implies that the first k columns of AP form a well-conditioned basis for the entire column space of A (within accuracy ε).

While Theorem 1 asserts the existence of a factorization (2.2) with the properties (2.4), (2.5), (2.6), it says nothing about the cost of constructing such a factorization numerically. The following theorem asserts that a factorization that satisfies bounds that are weaker than (2.4), (2.5), (2.6) by a factor of √n can be computed in O(mn²) operations.

Theorem 2. [Gu & Eisenstat] Given an m×n matrix A, afactorization of the form (2.2) that instead of (2.4, (2.5 and (2.6) satisfies the inequalities

$$\begin{matrix}{σ}_{k} ( {R}_{11} ) \geq \frac{1}{\sqrt{1 + nk ( n - k )}} {σ}_{k} ( A ) , & ( 2.8 ) \\ {σ}_{1} ( {R}_{22} ) \leq \sqrt{1 + nk ( n - k )} {σ}_{k + 1} ( A ) , & ( 2.9 )\end{matrix}$$

and
∥R₁₁⁻¹R₁₂∥_{F}≦√nk(n−k), (2.10)
can be computed in O(mn²) operations.

### Analytical Apparatus

The existence of factorization (1.2) is proven by applying Theorem 1 to both the columns and the rows of the matrix A. Theorem 2 then guarantees that the factorization can be computed efficiently.

The following theorem is the principal analytic tool of the present invention.

Theorem 3. Suppose that A is an m×n matrix and let k be such that 1≦k≦min(m,n). Then there exists a factorization

$$A = {P}_{L} [ \frac{I}{S} {A}_{S} [ I \vert T ] {P}_{R}^{*} + X , \qquad ( 3.1 )$$

where IεC^{k×k} is the identity matrix, P_{L} and P_{R} are permutation matrices, and A_{S} is the top left k×k submatrix of P_{L}*AP_{R}. In (3.1), the matrices SεC^{m-k×k} and TεC^{k×(n-k)} satisfy the inequalities
∥S∥_{F}≦\sqrt{k(m−k)}, and ∥T∥_{F}≦\sqrt{k(n−k)}, (3.2)
and the matrix X is small if the (k+1)-th singular value of A is small,
∥X∥₂≦σₖ₊₁(A){square root over (1+k(min(m,n)−k))}. (3.3)

Proof: The proof consists of two steps. First Theorem 1 is invoked to assert the existence of k columns of A that form a well-conditioned basis for the column space within accuracy σₖ₊₁(A); these are collected in the m×k matrix A_{CS}. Then Theorem 1 is invoked again to prove that k of the rows of A_{CS} form a well-conditioned basis for its row space. Without loss of generality, assume that m≧n and that vₖ(A)≠0.

For the first step factor A into matrices Q and R as specified by Theorem 1, letting P_{R} denote the permutation matrix. Splitting Q and R into submatrices Qᵢⱼ and Rᵢⱼ as in (2.3), the factorization (2.2) is reorganized as follows,

$${AP}_{R} = [ \frac{{Q}_{11}}{{Q}_{21}} ] [ {R}_{11} \vert {R}_{12} ] + [ \frac{{Q}_{12}}{{Q}_{22}} ] \\ [ 0 \vert {R}_{22} ] = [ \frac{{Q}_{11}}{{Q}_{21}} \frac{{R}_{11}}{{R}_{11}} ] [ I \vert {R}_{11}^{- 1} {R}_{12} ] + [ \begin{matrix}0 & {Q}_{12} {R}_{22} \\ 0 & {Q}_{22} {R}_{22}\end{matrix} ] . ( \text{?} \\ \text{?} \text{indicates text missing or illegible when filed}$$

The matrix TεC^{k×(n-k)} is now defined via the formula
T=R₁₁⁻¹R₁₂; (3.5)
T satisfies the inequality (3.2) by virtue of (2.6). The matrix XεC^{m×n} is defined as via the formula

$$X = [ \begin{matrix}0 & {Q}_{12} {R}_{22} \\ 0 & {Q}_{11} {R}_{22}\end{matrix} ] {P}_{R}^{*} , \qquad ( 3.6 )$$

which satisfies the inequality (3.3) by virtue of (2.5). Defining the matrix A_{CS}εC^{m×k} by

$${A}_{CS} = [ \frac{{Q}_{11}}{{Q}_{21}} \frac{{R}_{11}}{{R}_{11}} ] , \qquad ( 3.7 )$$

equation (3.4) is reduced to the form
AP_{R}=A_{CS}[I|T]+XP_{R}. (3.8)

An obvious interpretation of (3.8) is that A_{CS} consists of the first k columns of the matrix AP_{R} (since the corresponding columns of XP_{R} are identically zero).

The second step of the proof is to find k rows of A_{CS} forming a well-conditioned basis for its row-space. To this end, the transpose of A_{CS} is factored as specified by Theorem 1,
A_{CS}*P_{L}=\tilde{Q}└\tilde{R}₁₁|\tilde{R}₁₂┘. (3.9)

Transposing (3.9) and rearranging the terms, it follows that

$${P}_{L}^{*} {A}_{CS} = [ \frac{{\tilde{R}}_{11}^{*}}{{\tilde{R}}_{12}^{*}} ] {{Q}^{->}}^{*} = [ \frac{I}{{{\tilde{R}}_{12}^{*} ( {\tilde{R}}_{11}^{*} )}^{- 1}} ] {\tilde{R}}_{11}^{*} {\tilde{Q}}^{*} . \qquad ( 3.10 )$$

Multiplying (3.8) by P_{L}* and using (3.10) to substitute for P_{L}*A_{CS} it is obtained

$${P}_{L}^{*} {AP}_{R} = ⌊ \frac{I}{{{\tilde{R}}_{12}^{*} ( {\tilde{R}}_{11}^{*} )}^{- 1}} ⌋ {\tilde{R}}_{11}^{*} {\tilde{Q}}^{*} [ I \vert T ] + {P}_{L}^{*} {XP}_{R} . \qquad ( 3.11 )$$

(3.11) is converted into (3.1) by defining the matrices A_{S}εC^{k×k} and SεC^{(n-k)×k} via the formulae
A_{S}=\tilde{R}₁₁*\tilde{Q}*, and S=\tilde{R}₁₂*(\tilde{R}₁₁*)⁻¹, (3.12)
respectively.□

Remark 3. While the definition (3.5) serves its purpose within the proof of Theorem 3, it is somewhat misleading. Indeed, it is more reasonable to define T as a solution of the equation
∥R₁₁T−R₁₂∥₂≦σₖ₊₁(A)\sqrt{1+k(n−k)}. (3.13)

When the solution is non-unique a solution that minimizes ∥T∥_{F} is chosen. From the numerical point of view, the definition (3.13) is much preferable to (3.5) since it is almost invariably the case that R₁₁ is highly ill-conditioned, if not outright singular.

Introducing the notation

$${A}_{CS} = {P}_{L} [ \frac{I}{S} ] {A}_{S} ∈ {ℂ}^{n \times k} , and {A}_{RS} = {A}_{S} [ I \vert S ] {P}_{R} ∈ {ℂ}^{k \times m} , \qquad ( 3.14 )$$

It is observed that under the conditions of Theorem 3, the factorization (3.1) can be rewritten in the forms
A=A_{CS}[I|T]P_{R}*+X, (3.15)
and

$$A = {P}_{L} [ \frac{I}{S} ] {A}_{RS} + X . \qquad ( 3.16 )$$

The matrix A_{CS} consists of k of the columns of A, while A_{RS} consists of k of the rows. A_{S} is referred to as the skeleton of A, and to A_{CS} and A_{RS} as the column and row skeletons, respectively.

Remark 4. While Theorem 3 guarantees the existence of a well-conditioned factorization of the form (3.1), it says nothing about the cost of obtaining such a factorization. However, it follows immediately from Theorem 2 that a factorization (3.1) with the matrices S, T, and X satisfying the weaker bounds
∥S∥₂≦\sqrt{mk(m−k)}, and ∥T∥₂≦\sqrt{nk(n−k)}, (3.17)
and, with l=min(m,n),
∥X∥₂≦\sqrt{1+lk(l−k)}σₖ₊(A), (3.18)
can be constructed at the cost O(mnl).

Observation 1. The relations (3.1), (3.15), (3.16) have simple geometric interpretations. Specifically, (3.15) asserts that for a matrix A of rank k, it is possible to select k columns that form a well-conditioned basis of the entire column space. Let j₁, . . . ,jₖε{1, . . . ,n} denote the indices of those columns and let Xₖ=span(eⱼ₁, . . . , eⱼₖ)⊂Cⁿ (thus, Xₖ is the space of vectors whose only non-zero coordinates are xⱼ₁, . . . , xⱼₖ). According to Theorem 3, there exists an operator
Proj: C−Xₖ, (3.19)
defined by the formula

$$Proj = {P}_{R} [ \frac{I \vert T}{0} ] {P}_{R}^{*} , \qquad ( 3.20 )$$

such that the diagram 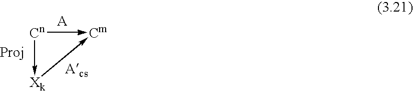
is commutative. Here, A_{CS}′ is the m×n matrix formed by setting all columns of A except j₁, . . . , jₖ to zero. Furthermore, σ₁(Proj)/σₖ(Proj)≦\sqrt{1+k(n−k)}. Similarly, equation (3.16) asserts the existence of k rows, say with indices i₁, . . . , iₖε{1, . . . ,m}, that form a well-conditioned basis for the entire row-space. Setting Yₖ=span(eᵢ₁, . . . , e₁ₖ)⊂C^{m}, there exists an operator
Eval: Yₖ→C, (3.22)
defined by

$$Eval = {P}_{L} [ \frac{I}{S} \vert 0 ] {P}_{L}^{*} . \qquad ( 3.23 )$$

such that the diagram 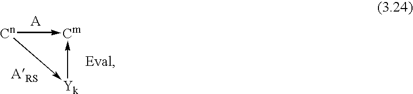
is commutative. Here, A_{RS}′ is the m×n matrix formed by setting all rows of A except i₁, . . . , iₖ to zero. Furthermore, σσ₁(Eval)/σₖ(Eval)≦√1+k(m−k). Finally, the geometric interpretation of (3.1) is the combination of the diagrams (3.21) and (3.24),

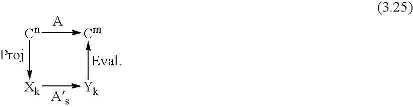

Here, A_{S}′ is the m×n matrix formed by setting all entries of A, except those at the intersection of the rows i₁, . . . iₖ with the columns j₁, . . . , jₖ, to zero.

As a comparison, the diagram was considered 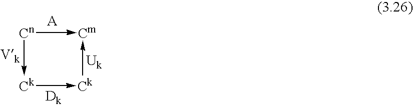
obtained when the SVD is used to compress the matrix AυC^{m×n}. Here, Dₖ is the k×k diagonal matrix formed by the k largest singular values of A, and Vₖ and Uₖ are column matrices containing the corresponding right and left singular vectors, respectively. The factorization (3.25) has the advantage over (3.26) that the mappings Proj and Eval leave k of the coordinates invariant. This is gained at the price of non-orthonormality of these mappings.

### Numerical Apparatus

In this section, a simple and reasonably efficient procedure for computing the factorization is presented (3.1). It has been extensively tested and consistently produces factorizations that satisfy the bounds (3.17). While there exist matrices for which this simple approach will not work well, they appear to be exceedingly rare.

Given an m×n matrix A, the first step (out of four) is to apply the pivoted Gram-Schmidt process to its columns. The process is halted when the column space has been exhausted to a preset accuracy a, leaving a factorization
AP_{R}=Q[R₁₁|R₁₂], (4.1)
where P_{R}εC^{m×n} is a permutation matrix, QεC^{m×k} has orthonormal columns, R₁₁εC^{k×k} is upper triangular, and R₁₂εC^{k×(n-k)}.

The second step is to find a matrix TεC^{k×(n-k)} that solves the equation
R₁₁T=R₁₂ (4.2)
to within accuracy ε. When R₁₁ is ill-conditioned, there is a large set of solutions; one is selected for which ∥T∥_{F} is small.

Letting A_{CS}εC^{m×k} denote the matrix formed by the first k columns of AP_{R}, the following factorization is obtained
A=A_{CS}[I|]P_{R}*. (4.3)

The third and the fourth steps are entirely analogous to the first and the second, but are concerned with finding k rows of A_{CS} that form a basis for its row-space. They result in a factorization

$${A}_{CS} = {P}_{L} [ \frac{I}{S} ] {A}_{S} . \qquad ( 4.4 )$$

The desired factorization is now obtained by inserting (4.4) into (4.3):

$$A = {P}_{L} [ \frac{I}{S} ] {A}_{S} [ I \vert T ] {P}_{R}^{*} . \qquad ( 4.5 )$$

For this technique to be successful, it is crucially important that the Gram-Schmidt factorization be performed accurately. Modified Gram-Schmidt or the method using Householder reflectors are not accurate enough. Instead, a technique that is based on modified Gram-Schmidt is used, but that at each step re-orthogonalizes the vector chosen to add to the basis before adding it. In exact arithmetic, this step would be superfluous, but in the presence of round-off error it greatly increases the quality of the factorization generated, see e.g. Å Björck, Numerics of Gram-Schmidt orthogonalization, Linear Algebra Appl., vol. 197/198, pp. 297-316, 1994, which is incorporated herein by reference in its entirety.

### Application: an Accelerated Direct Solver for Integral Equations

The matrix compression technique presented herein is used to construct an accelerated direct solver for boundary integral equations with non-oscillatory kernels. Upon discretization, such equations lead to dense systems of linear equations, and iterative methods combined with fast matrix-vector multiplication techniques are commonly used to obtain the solution. Many such fast multiplication techniques take advantage of the fact that the off-diagonal blocks of the discrete system typically have low rank. Employing the matrix compression techniques presented in herein, this low-rank property was used to accelerate direct, rather than iterative, solution techniques. The method uses no machinery beyond what is described in herein and is applicable to most integral equations involving non-oscillatory kernels.

For concreteness, the equation was considered
u(x)+∫_{Γ}K(x,y)u(y)dy=f(x), for xεΓ, (5.1)
where Γ is some contour and K(x,y) is a non-oscillatory kernel. The function u represents an unknown “charge” distribution on Γ that is to be determined from the given function f. The method works for almost any contour but for simplicity, assume that the contour consists of p disjoint pieces, Γ=Γ₁+ . . . +Γₚ, where all pieces have similar size (an example is given in FIG. 3). In fact, to simplify the formulas, set p=3 was used.

Discretizing each contour Γ, using n points, the equation (5.1) takes the form

$$[ \begin{matrix}{M}^{( 1 , 1 )} & {M}^{( 1 , 2 )} & {M}^{( 1 , 3 )} \\ {M}^{( 2 , 1 )} & {M}^{( 2 , 2 )} & {M}^{( 2 , 3 )} \\ {M}^{( 3 , 1 )} & {M}^{( 3 , 2 )} & {M}^{( 3 , 3 )}\end{matrix} ] [ \begin{matrix}{u}^{( 1 )} \\ {u}^{( 2 )} \\ {u}^{( 3 )}\end{matrix} ] = [ \begin{matrix}{f}^{( 1 )} \\ {f}^{( 2 )} \\ {f}^{( 3 )}\end{matrix} ] , \qquad ( 5.2 )$$

where u⁽ⁱ⁾εCⁿ and f⁽ⁱ⁾εCⁿ are discrete representations of the unknown boundary charge distribution and the right hand side associated with Γᵢ, and M^{(i,j)}εC^{n×n} is a dense matrix representing the evaluation of a potential on Γ, caused by a charge distribution on Γ.

The interaction between Γ₁ and the rest of the contour is governed by the matrices

$${H}^{( 1 )} = [ {M}^{( 1 , 2 )} \vert {M}^{( 1 , 3 )} ] ∈ {ℂ}^{n \times 2 n} , and {V}^{( 1 )} = [ \frac{{M}^{( 2 , 1 )}}{{M}^{( 3 , 1 )}} ] ∈ {ℂ}^{2 n \times n} . \qquad ( 5.3 )$$

For non-oscillatory kernels, these matrices are typically highly rank-deficient. Let k denote an upper bound on their ranks (to within some preset level of accuracy ε). By virtue of (3.16), there exist k rows of H⁽¹⁾ which form a well-conditioned basis for all the n rows. In other words, there exists a well-conditioned n×n matrix L⁽¹⁾ (see Remark 6) such that

$${L}^{( 1 )} {H}^{( 1 )} = [ \frac{{H}_{RS}^{( 1 )}}{Z} ] + O ( ɛ ) , \qquad ( 5.4 )$$

where H_{RS}⁽¹⁾ is a k×2n matrix formed by k of the rows of H⁽¹⁾ and Z is the (n−k)×2n zero matrix. There similarly exist an n×n matrix R⁽¹⁾ such that

$${V}^{( 1 )} {R}^{( 1 )} = [ {V}_{CS}^{( 1 )} \vert {Z}^{*} ] + O ( ɛ ) , \qquad ( 5.5 )$$

where V_{CS}⁽¹⁾ is a 2n×k matrix formed by k of the columns of V⁽¹⁾. For simplicity, assume that the off-diagonal blocks have exact rank at most k and ignore the error terms.

The relations (5.4) and (5.5) imply that by restructuring equation (5.2) as follows,

$$[ \begin{matrix}{L}^{( 1 )} {M}^{( 1 , 1 )} {R}^{( 1 )} & {L}^{( 1 )} {M}^{( 1 , 2 )} & {L}^{( 1 )} {M}^{( 1 , 3 )} \\ {M}^{( 2 , 1 )} {R}^{( 1 )} & {M}^{( 2 , 2 )} & {M}^{( 2 , 3 )} \\ {M}^{( 3 , 1 )} {R}^{( 1 )} & {M}^{( 3 , 2 )} & {M}^{( 3 , 3 )}\end{matrix} ] [ \begin{matrix}{( {R}^{( 1 )} )}^{- 1} {u}^{( 1 )} \\ {u}^{( 2 )} \\ {u}^{( 3 )}\end{matrix} ] = [ \begin{matrix}{L}^{( 1 )} {f}^{( 1 )} \\ {f}^{( 2 )} \\ {f}^{( 3 )}\end{matrix} ] , \qquad ( 5.6 )$$

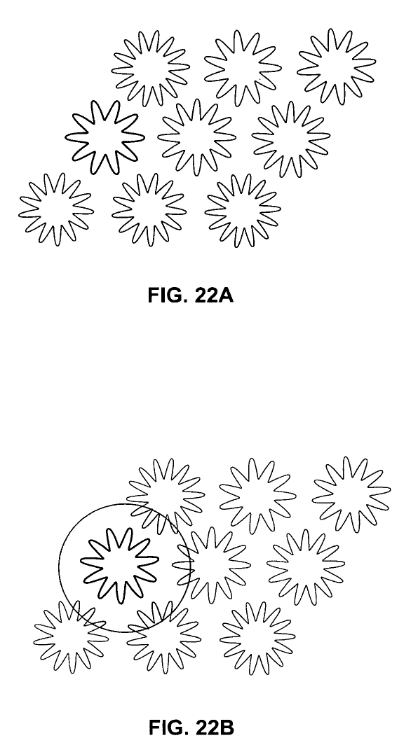

large blocks of zeros in the matrix are introduced, as shown in FIG. 21(a).

In FIGS. 21(A)-(C), zeros are introduced into the matrix in three steps: FIG. 21(a) interaction between Γ₁ and the other contours is compressed, FIG. 21(b) interaction with Γ₂ is compressed, FIG. 21(c) interaction with Γ₃ is compressed. The small black blocks are of size k×k and consist of entries that have not been changed beyond permutations, grey blocks refer to updated parts and white blocks are all zero entries.

Next, the interaction between Γ₂ and the rest of the contour is compressed to obtain the matrix structure shown in FIG. 21(b). Repeating the process with Γ₃, the final structure shown in FIG. 21(c) was obtained. At this point, matrices R⁽ⁱ⁾ and L⁽ⁱ⁾ was constructed and formed the new system

$$\begin{matrix}[ \begin{matrix}{L}^{( 1 )} {M}^{( 1 , 1 )} {R}^{( 1 )} & {L}^{( 1 )} {M}^{( 1 , 2 )} {R}^{( 2 )} & {L}^{( 1 )} {M}^{( 1 , 3 )} {R}^{( 3 )} \\ {L}^{( 2 )} {M}^{( 2 , 1 )} {R}^{( 1 )} & {L}^{( 2 )} {M}^{( 2 , 2 )} {R}^{( 2 )} & {L}^{( 2 )} {M}^{( 2 , 3 )} {R}^{( 3 )} \\ {L}^{( 3 )} {M}^{( 3 , 1 )} {R}^{( 1 )} & {L}^{( 3 )} {M}^{( 3 , 2 )} {R}^{( 2 )} & {L}^{( 3 )} {M}^{( 3 , 3 )} {R}^{( 3 )}\end{matrix} ] [ \begin{matrix}{( {R}^{( 1 )} )}^{- 1} {u}^{( 1 )} \\ {( {R}^{( 2 )} )}^{- 1} {u}^{( 2 )} \\ {( {R}^{( 3 )} )}^{- 1} {u}^{( 3 )}\end{matrix} ] = \\ [ \begin{matrix}{L}^{( 1 )} {f}^{( 1 )} \\ {L}^{( 2 )} {f}^{( 2 )} \\ {L}^{( 3 )} {f}^{( 3 )}\end{matrix} ] ,\end{matrix} \qquad ( 5.7 )$$

whose matrix is shown in FIG. 21(c). The k×k non-zero parts of the off-diagonal blocks are submatrices of the original n×n off-diagonal blocks. The parts of the matrix that are shown as grey in the figure represent interactions that are internal to each contour. These n−k degrees of freedom per contour can be eliminated by performing a local, O(n³), operation for each contour. This leaves a dense system of 3×3 blocks, each of size k×k. Thus, the problem size was reduced by a factor of n/k.

Remark 5. For the algorithm presented above, the compression of the interaction between a fixed contour and its p−1 fellows is quite costly since it requires the construction and compression of the large matrices H⁽¹ⁱ⁾εC^{n×(p-1)n} and V⁽ⁱ⁾εC^{(p-1)n×n}. In the numerical examples presented below, this step is avoided by constructing matrices L⁽ⁱ⁾ and R⁽ⁱ⁾ that satisfy (5.4) and (5.5) through an entirely local procedure. How this is done was illustrated by considering the contours in FIG. 22(a) and finding the transforms that compress the interaction of the contour Γᵢ (drawn with a bold line) with the remaining ones. This can be done by compressing the interaction between Γᵢ and an artificial contour Γ_{artif} that surrounds Γᵢ (as shown in FIG. 22(b)) combined with the parts of the other contours that penetrate it. This procedure works for any potential problem for which the Green's identities hold. The computational cost for one compression is O(kn²) rather than the O(pkn²) cost for constructing and compressing the entire H⁽ⁱ⁾ and V⁽ⁱ⁾.

In order to determine the R⁽ⁱ⁾ and L⁽ⁱ⁾ that compress the interaction between Γᵢ (shown in bold) and the remaining contours, it is sufficient to consider only the interactions between the contours drawn with a solid line in FIG. 22(b).

To sum up: The accelerated solver consists of four steps. For a problem involving p contours, each of which is discretized using n nodes and having off-diagonal blocks of rank at most k, they are:

1. The off-diagonal blocks are skeletonized and the diagonal n×n blocks are updated at a cost of O(pkn²) using the technique described in Remark 5.

2. The n−k degrees of freedom that represent internal interactions for each contour are eliminated at a cost of O(pn³).

3. The reduced kp×kp system is solved at a cost of O(k³p³).

4. The solution of the original system is reconstructed from the solution of the reduced problem through p local operations at a cost of O(pn²).

The third step is typically the most expensive one with an asymptotic cost of t^{(comp)}˜ck³p³. The cost of a solution of the uncompressed equations is t^{(uncomp)}˜cn³p³. Consequently;

$$Speed \text{-} up = \frac{{t}^{( uncomp )}}{{t}^{( comp )}} ∼ {( \frac{n}{k} )}^{3} .$$

Remark 6. The existence of the matrices L⁽¹⁾ and R⁽¹⁾ are direct consequences of (3.16) and (3.15), respectively. Specifically, substituting H⁽¹⁾ for A in (3.16), obtained

$${P}_{L}^{*} {H}^{( 1 )} = [ \frac{I}{S} ] {H}_{RS}^{( 1 )} , \qquad ( 5.8 )$$

where H_{RS}⁽¹⁾ is the k×2n matrix consisting of the top k rows of P_{L}*H⁽¹⁾. The relation (5.4) now follows from (5.8) by defining

$${L}^{( 1 )} = ⌊ \begin{matrix}I & 0 \\ - S & I\end{matrix} ⌋ {P}_{L}^{*} . \qquad ( 5.9 )$$

We note that the largest and smallest singular values of L⁽¹⁾satisfy
σ₁(L⁽¹⁾)≦(1+∥S∥ₗ_{²}²)^{1/2,}
σₙ(L⁽¹⁾)≧(1+∥S∥ₗ_{²}²)^{1/2}. (5.10)

Thus cond(L⁽¹⁾)≦1+∥S∥ₗ_{²}², which is of moderate size according to Theorem 3. The matrix R⁽¹⁾ is similarly constructed by forming the column skeleton of V⁽¹⁾.

Remark 7. Equations (5.4) and (5.5) have simple heuristic interpretations: Equation (5.4) says that it is possible to choose k points on the contour Γ₁ in such a way that when a field generated by charge distributions on the rest of the contour is known at those points, it is possible to extrapolate the field at the remaining points on Γ₁ from those values. Equation (5.5) says that it is possible to choose k points on Γ₁ in such a way that any field on the rest of the contour generated by charges on Γ₁, can be replicated by placing charges only on those k points.

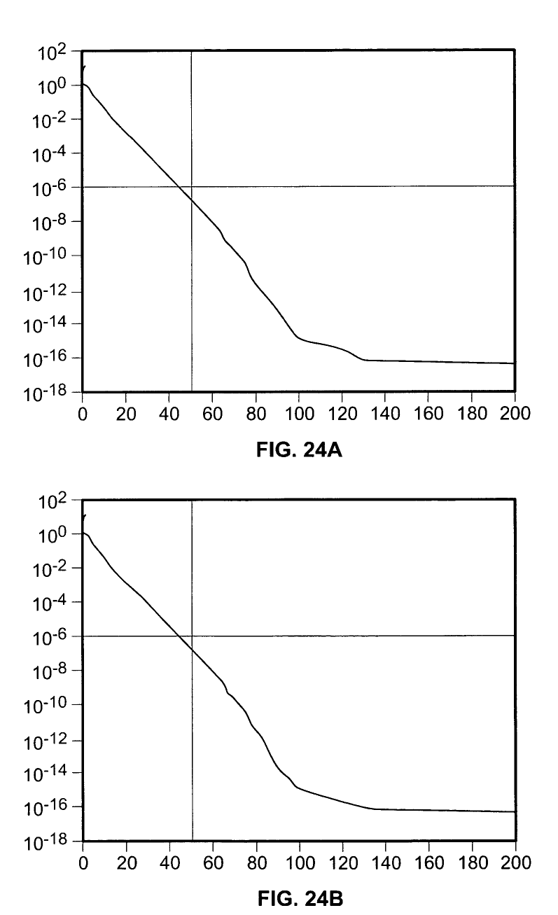

Remark 8. It is sometimes advantageous to choose the same k points when constructing the skeletons of H⁽ⁱ⁾ and V⁽ⁱ⁾. This can be achieved by compressing the two matrices jointly, for instance by forming the row skeleton of [H⁽ⁱ⁾|(V⁽ⁱ⁾)*]. In this case L⁽ⁱ⁾=(R⁽ⁱ⁾)*. When this is done, the compression ratio deteriorates since the singular values of [H⁽ⁱ⁾|(V⁽ⁱ⁾)] decay slower than those of either H⁽ⁱ⁾ or V⁽ⁱ⁾, as is seen by comparing FIGS. 24 and 25.

Remark 9. When the solution of equation (5.2) is sought for multiple right-hand sides, the cost of the first solve is O(mnk). Subsequent solves can be preformed using O(p²k²+pn²) operations rather than O(p²n²) for an uncompressed solver.

Remark 10. The direct solver has a computational complexity that scales cubically with the problem size N and is thus not a “fast” algorithm. However, by applying the techniques presented recursively, it is possible to reduce the asymptotic complexity to O(N^{3/2}), and possibly even O(N log N).

### Numerical Results

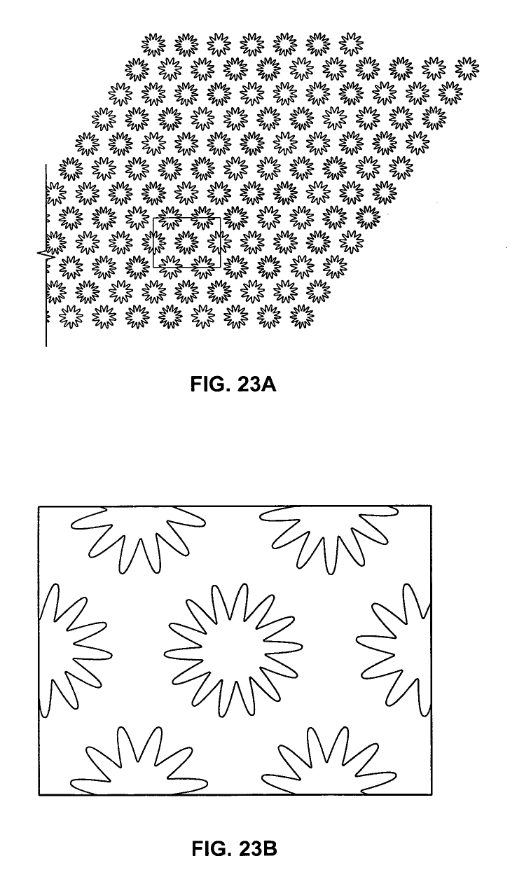

The algorithm described herein has been computationally tested on the second kind integral equation obtained by discretizing an exterior Dirichlet boundary value problem using the double layer kernel. The contours used consisted of a number of jagged circles arranged in a skewed square as shown in FIGS. 23(a)-(b). The number of contours p ranged from 8 to 128. For this problem, n=200 points per contour were required to obtain a relative accuracy of ε=10⁻⁶. To this level of accuracy, no H⁽ⁱ⁾ or V⁽ⁱ⁾ had rank exceeding k=50. As an example, shown in FIGS. 24(a)-(b) the singular values of the matrices H⁽ⁱ⁾ and V⁽ⁱ⁾ representing interactions between the highlighted contour in FIG. 22(a) and the remaining ones.

The contours used for the numerical calculations with p=128. Picture FIG. 23(a) shows the full contour and a box (which is not part of the contour) that indicates the location of the close-up shown in FIG. 23(b).

FIGS. 24(A)-(B) are plots of the singular values of (a) V⁽ⁱ⁾ and (b) H⁽ⁱ⁾ for a discretization of the double layer kernel associated with the Laplace operator on the nine contours depicted in FIG. 22(a). In the example shown, the contours were discretized using n=200 points, giving a relative discretization error of about 10⁻⁶. The plots show that to that level of accuracy, the matrices V⁽ⁱ⁾εC^{1600×200} and H⁽ⁱ⁾εC^{200×1600} have numerical rank less than k=50 (to accuracy 10⁻⁶).

The algorithm described herein was implemented in FORTRAN and run on a 2.8 GHz Pentium IV desktop PC with 512 Mb RAM. The CPU times for a range of different problem sizes are presented in Table 1. The data presented supports the following claims for the compressed solver:

For large problems, the CPU time speed-up approaches the estimated factor of (n/k)³=64.

The reduced memory requirement make large problems amenable to direct solution.

TABLE 1
CPU times in seconds for solving (5.2). p is the number of contours.
t^{(uncomp)} is the CPU time required to solve the uncompressed
equations; the numbers in italics are estimated since these problems did
not fit in RAM. t^{(comp)} is the CPU time to solve the equations using
the compression method; this time is split between tᵢₙᵢₜ^{(comp)}, the time
to compress the equations, and tₛₒₗᵥₑ^{(comp)}, the time to solve the
reduced system of equations. The error is the relative error incurred by the
compression measured in the maximum norm when the right hand side is
a vector of ones. Throughout the table, the numbers in parenthesis refer
to numbers obtained whenteh techinque of Remark 5 is not used.

| p | t^{(uncomp)} | t^{(comp)} | tᵢₙᵢₜ^{(comp)} | tₛₒₗᵥₑ^{(comp)} | Error |
|---|---|---|---|---|---|
| 8 | 5.6 | 2.0 (4.6) | 1.6 (4.1) | 0.05 | 8.1 · 10⁻⁷ (1.4 · 10⁻⁷) |
| 16 | 50 | 4.1 (16.4) | 3.1 (15.5) | 0.4 | 2.9 · 10⁻⁶ (2.8 · 10⁻⁷) |
| 32 | 451 | 13.0 (72.1) | 6.4 (65.3) | 5.5 | 4.4 · 10⁻⁶ (4.4 · 10⁻⁷) |
| 64 | 3700 | 65 (270) | 14 (220) | 48 | — |
| 128 | 30000 | 480 (1400) | 31 (960) | 440 | — |

FIG. 25 is a plot of the singular values of X⁽ⁱ⁾=[H⁽ⁱ⁾|(V⁽ⁱ⁾)*] where H⁽ⁱ⁾ and V⁽ⁱ⁾ are as in FIG. 24. The numerical rank of X⁽ⁱ⁾ is approximately 80, which is larger than the individual ranks of H⁽ⁱ⁾ and V⁽ⁱ⁾.

Remark 11. In the interest of simplicity, the program was forced to use the same compression ratio k/n for each contour. In general, it detects the required interaction rank of each contour as its interaction matrices are being compressed and uses different ranks for each contour.

A “compression” scheme for low-rank matrices is described herein. For a matrix A of dimensionality m×n and rank k, the factorization can be applied to an arbitrary vector for the cost of (n+m−k)·k operations, after a significant initial factorization cost; this is marginally faster than the cost (n+m)·k produced by the SVD. The factorization cost is roughly the same as that for the rank-revealing QR decomposition of A.

A more important advantage of the proposed decomposition is the fact that it expresses all of the columns of A as linear combinations of k appropriately selected columns of A, and all of the rows of A as linear combinations of k appropriately selected rows of A. Since each of the basis vectors (both row and column) produced by the SVD (or any other classical factorizations) is a linear combination of all rows (columns) of A, the decomposition is considerably easier to manipulate; this point was illustrated by constructing an accelerated scheme for the direct solution of integral equations of potential theory in the plane.

A related advantage of the proposed decomposition is the fact that one frequently encounters collections of matrices such that the same selection of rows and columns can be used for each matrix to span its row and column space (in other words, there exist fixed P_{L} and P_{R} such that each matrix in the collection has a decomposition (3.1) with small matrices S and T). Once one matrix in such a collection has been factorized, the decomposition of the remaining ones is considerably simplified since the skeleton of the first can be reused. If it should happen that the skeleton of the first matrix that was decomposed is not a good choice for some other matrix, this is easily detected (since then no small matrices S and T can be computed) and the global skeleton can be extended as necessary.

Several other numerical procedures were constructed using the approach described herein. In particular, a code has been designed for the (reasonably) rapid solution of scattering problems in the plane based on the direct (as opposed to iterative) solution of the Lippman-Schwinger equation; the scheme utilizes the same idea as that used in Yu Chen, Fast direct solver for the Lippmann-Schwinger equation, Advances in Computational Mathematics, vol. 16, pp. 175-190, 2002, which is incorporated by reference in its entirety, and has the same asymptotic CPU time estimate O(N^{3/2}) for a square region discretized into N nodes. However, the CPU times obtained by us are a significant improvement on these reported in Yu Chen.

It is appreciated that the techniques of the present invention can be utilized to construct an order O(N log N) (or possibly even order order O(N) (!)) scheme for the solution of elliptic PDEs in both two and three dimensions, provided that the associated Green's function is not oscillatory.

### REFERENCES

[1] Ming Gu and Stanley C. Eisenstat, Efficient algorithms for computing a strong rank-revealing QR factorization, SIAM J. Sci. Comput. 17 (1996), no.4, 848-869.
[2] B. Alpert, G. Beylkin, R. Coifman, V. Rokhlin, Wavelet-like bases for the fast solution of second-kind integral equations, SIAM J. Sci. Comput., vol. 14, pp. 159-184, 1993.
[3] G. Beylkin, R. Coifman, and V. Rokhlin, Fast wavelet transforms and numerical algorithms I, Communications on Pure and Applied Mathematics, 14:141-183 (1991).
[4] Yu Chen, Fast direct solver for the Lippmann-Schwinger equation, Advances in Computational Mathematics, vol. 16, pp. 175-190, 2002.
[5] G. H. Golub, C. F. Van Loan, Matrix Computations, Johns Hopkins University Press, 1989.
[6] Å Björck, Numerics of Gram-Schmidt orthogonalization, Linear Algebra Appl., vol. 1974198, pp. 297-316, 1994.
[7] G. Beylkin, On multiresolution methods in numerical analysis, Documenta Mathematica, Extra Volume ICM 1998, Im, pp. 481-490, 1998.
[8] G. W. Stewart, Matrix Algorithms, Vol. I, SIAM, Philadelphia 1998.

In view of the foregoing description, numerous modifications and alternative embodiments of the invention will be apparent to those skilled in the art. Accordingly, this description is to be construed as illustrative only and is for the purpose of teaching those skilled in the art the best mode of carrying out the invention. Details of the structure may be varied substantially without departing from the spirit of the invention, and the exclusive use of all modifications, which come within the scope of the appended claim, is reserved.

1. A method for the solution of linear matrix equations wherein said method uses the presence of large submatricies of said matrix equation, said submatrices having low rank to prescribed numerical precision.

2. The method of claim 1 wherein said method involves the compression of at least one of said matrix or said submatrices.

3. The method of claim 2 further involving the compression of the inverse of said matrix equation.

4. The method of claim 1, wherein said method involves the hierarchical compression of both said matrix and the inverse of said matrix.

5. The method of claim 4 wherein said hierarchical compression includes the step of selecting a subset of the rows and a subset of the columns of at least one matrix or submatrix.

6. The method of claim 5 wherein said hierarchical compression also includes the construction of two linear operators, Eval and Expand, such that the matrix or submatrix being compressed is equal to the composition of Eval times the compressed matrix or sub-matrix times Expand.

7. A system for solving linear matrix equations wherein said system uses the presence of large submatricies of said matrix equation, said submatrices having low rank to prescribed numerical precision.

8. A computer readable medium comprising code for a method for the solution of linear matrix equations, wherein said method uses the presence of large submatricies of said matrix equation, said submatrices having low rank to prescribed numerical precision.
